(19) United States
(12) Patent Application Publication
(10) Pub. No.: US 2025/0190779 A1
(43) Pub. Date: Jun. 12, 2025

(54) SYSTEMS AND METHODS FOR AUTOMATIC FORECASTING ALGORITHM SELECTION BASED ON TIME SERIES CHARACTERISTICS

(71) Applicant: ORACLE INTERNATIONAL CORPORATION, Redwood Shores, CA (US)

(72) Inventors: Ankit Kumar AGGARWAL, Mumbai (IN); Hansa MEGHWANI, Bangalore (IN); Sharmily SIDHARTHA, Bangalore (IN); Vikas PANDEY, Shahdol (IN); Jie XING, Redmond, WA (US)

(21) Appl. No.: 18/532,053

(22) Filed: Dec. 7, 2023

(51) Int. Cl. G06N 3/08; G06N 3/0455

(52) U.S. Cl. CPC G06N 3/08; G06N 3/0455

(57) ABSTRACT

Systems, methods, and other embodiments associated with characteristics-based selection of time series forecast algorithms are described. In one embodiment, a method includes analyzing each time series in a training set of time series to yield characteristics vectors for the time series. The method trains an auto-encoder to minimize error: (1) between bottleneck layer and the characteristics vectors, and (2) between input layer and output layer. The method generates new characteristics vectors that fill gaps between neighboring characteristics. The method inputs the new characteristics vectors to the bottleneck layer to generate a testing set of time series. The method tests forecasting algorithms using the testing set to find forecasting error. The method trains a ranking function to assign a rank to each forecasting algorithm based on a provided characteristics vector. And, the method automatically selects one of the forecasting algorithms to monitor an additional time series based on the ranks.

### BACKGROUND

Time series of data values may be monitored using forecasting algorithms that predict what the data values are expected to be. Existing methods to select forecasting algorithms for a given time series are resource-intensive, and may yet select an inaccurate forecasting algorithm for the given time series.

### BRIEF DESCRIPTION OF THE DRAWINGS

The accompanying drawings, which are incorporated in and constitute a part of the specification, illustrate various systems, methods, and other embodiments of the disclosure. It will be appreciated that the illustrated element boundaries (e.g., boxes, groups of boxes, or other shapes) in the figures represent one embodiment of the boundaries. In some embodiments one element may be implemented as multiple elements or that multiple elements may be implemented as one element. In some embodiments, an element shown as an internal component of another element may be implemented as an external component and vice versa. Furthermore, elements may not be drawn to scale.

FIG. 1 illustrates one embodiment of an algorithm selection system associated with characteristics-based selection of time series forecast algorithms.

FIG. 2 illustrates one embodiment of an algorithm selection method associated with characteristics-based selection of time series forecast algorithms.

FIGS. 3A-31 show an example of automated, incremental construction of a forecasting algorithm selector at various stages of the construction.

FIG. 4 illustrates an embodiment of a computing system configured with the example systems and/or methods disclosed.

### DETAILED DESCRIPTION

Systems and methods are described herein that provide automatic selection of forecasting algorithms for a time series based on characteristics that describe the behavior of the time series. In one embodiment, the algorithm selection system trains and modifies an auto-encoder, and uses the auto encoder to train a classification model to select a forecast model best suited to a time series based on characteristics of the time series.

For example, the algorithm selection system configures an auto-encoder to generate time series from the descriptive characteristics. Then, the algorithm selection system uses the auto encoder to generate from a comprehensive set of the characteristics. The algorithm selection system determines performance of various forecasting algorithms in relation to the characteristics. The algorithm selection system trains a machine learning model to rank the models by performance based on the characteristics. And, the algorithm selection system selects a model to monitor a time series based on an ML ranking for the model.

In one embodiment, the algorithm selection system outperform methods such as Feature-based FORecast Model Selection (FFORMS) because the algorithm selection system described herein covers a broader range of domains that FFORMS does not address. Thus, advantageously, the algorithm selection system is domain-agnostic.

It should be understood that no action or function described or claimed herein is performed by the human mind. No action or function described or claimed herein can be practically performed in the human mind. Any interpretation that any action or function described or claimed herein can be performed in the human mind is inconsistent with and contrary to this disclosure.

### Definitions

As used herein, the term “time series” refers to a data structure in which a series of data points or readings (such as observed or sampled values) are indexed in time order. In one embodiment, the data points of a time series may be indexed with an index such as a point in time described by a time stamp and/or an observation number. For example, a time series is a sequence of observations over time from one variable (such as heart rate, vibration, temperature, or other physical phenomena).

As used herein, the term “vector” refers to a data structure that includes a set of data points that describe one particular entity. For example, a “characteristics vector” includes a set of data points that describe various properties of a time series. Also, for example, a time series may be represented as a vector.

As used herein, the term “characteristics” when used with reference to time series refers to properties or features that describe behavior of a time series.

### Example Algorithm Selection System

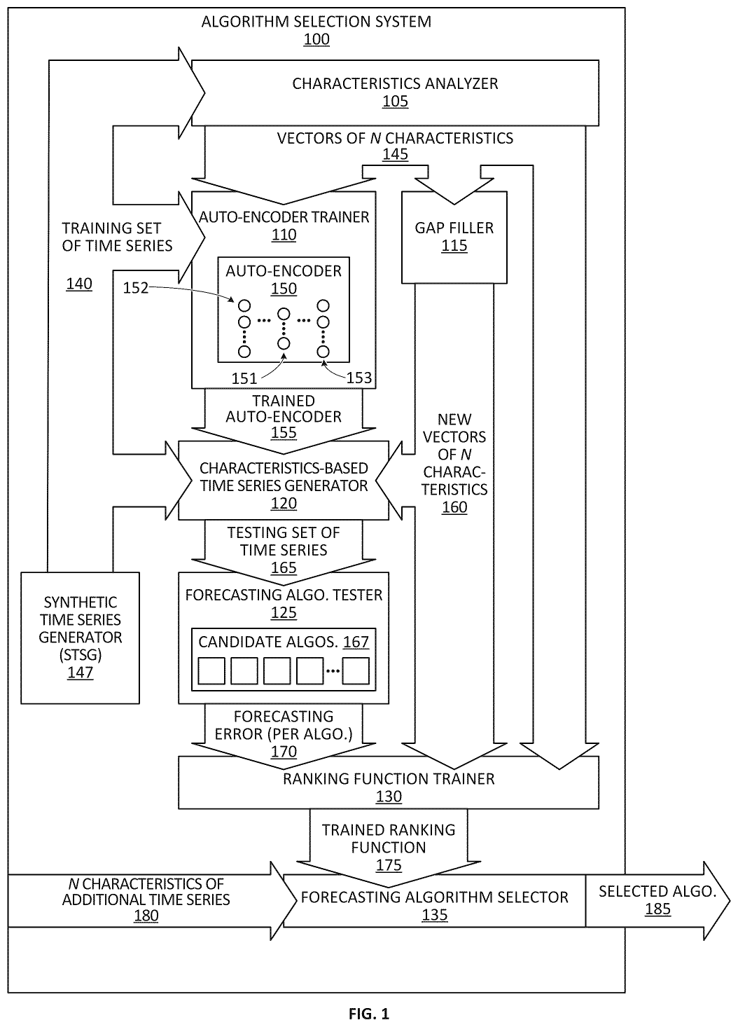

FIG. 1 illustrates one embodiment of an algorithm selection system 100 associated with characteristics-based selection of time series forecast algorithms. Algorithm selection system 100 includes characteristics analyzer 105, auto-encoder trainer 110, gap filler 115, characteristics-based time series generator 120, forecasting algorithm tester 125, ranking function trainer 130, and forecasting algorithm selector 135.

In one embodiment, characteristics analyzer 105 is configured to analyze each time series in a training set of time series 140 to yield a vector of N characteristics 145 for each of the time series. In one embodiment, the characteristics analyzer 105 is configured to access a training set of time series 140, identify N characteristics of each time series in the training set, and generate a vector of the N characteristics 145 for each time series in the training set of time series 140 as output. In one embodiment, characteristics analyzer 105 is configured to perform a set or panel of analyses on the individual time series in the training set of time series. Each analysis evaluates a time series for a specific characteristic (or property or feature), and produces a values of that characteristic for an individual time series.

In one embodiment, the training set of time series 140 is generated by a synthetic time series generator (STSG) 147. STSG 147 is configured to generate simulated time series that include outliers, multiple seasonalities, change points, intermittency, and high-level effects, thereby producing realistic simulations of time series behavior. Or, in one embodiment, the training set of time series 140 may be accessed from a database of real-world time series that include outliers, multiple seasonalities, change points, intermittency, and high-level effects.

In one embodiment, auto-encoder trainer 110 is configured to train an auto-encoder 150 using a loss function that minimizes discrepancies between: (1) bottleneck layer 151 activations in the auto-encoder 150 and the vectors of characteristics 145 for the time series and (2) an input layer 152 and an output layer 153 of the auto-encoder 150. For example, the loss function minimizes discrepancies between activations of nodes in bottleneck layer 151 of the auto encoder 150 and the vector of N characteristics for each individual time series of the training set of time series 140 that is entered at the input layer 152. And, the loss function minimizes discrepancies between values of the individual time series entered at input layer 152 of the auto-encoder 150 and values at the output layer 153. The training produces a trained auto-encoder 155.

In one embodiment, gap filler 115 is configured to generate one or more new vectors of N characteristics 160 by minimizing gaps between neighboring points in an N-dimensional characteristics space. In one embodiment, gap filler 115 is configured to minimize the gaps by t-distributed stochastic neighbor embedding to produce the new vectors of N characteristics 160. The new vectors of N characteristics fill the gaps in the N-dimensional characteristics space.

In one embodiment, characteristics-based time series generator 120 is configured to generate a testing set of time series 165 based at least in part on inputting the new vectors of N characteristics 160 to the bottleneck layer 151 of the trained auto-encoder 155. In one embodiment, the bottleneck layer 151 is set as an input to the trained auto-encoder 155 to cause the trained auto-encoder 155 to behave as a time series generator. In this configuration, the trained auto-encoder 155 is configured to accept vectors of values for the N characteristics (such as new vectors of N characteristics 160) at the bottleneck layer 151 and produce from them at the output layer 153 a time series exhibiting the values for the N characteristics. In one embodiment, characteristics-based time series generator 120 is configured to input one or more of the new vectors of N characteristics 160 into trained auto encoder 155 to produce a gap-filling set of time series. The gap-filling set of time series produced by auto encoder 155 is thus made up of time series that exhibit the new vectors of N characteristics 160 that fill or close up gaps in the N-dimensional characteristics space. The gap-filling set of time series may also be referred to more generally as a gap-based set of time series.

In one embodiment, characteristics-based time series generator 120 is configured to generate the testing set of time series 165 by combining or mixing the training set of time series 140 with further time series generated by the trained auto-encoder 155 from the new vectors of N characteristics 160. For example, the characteristics-based time series generator 120 may combine the training set of time series 140 with a gap-filling set of time series to generate the testing set of time series 165 as a combined set of time series. In one embodiment, characteristics-based time series generator 120 is configured to generate the testing set of time series 165 from the new vectors of N characteristics 160 using the trained auto-encoder 155, without combination with the training set of time series 140.

In one embodiment, forecasting algorithm tester 125 is configured to input the testing set of time series 165 to each of a set of candidate forecasting algorithms 167, and calculate forecasting error 170 for each algorithm based on performance for each time series. The candidate forecasting algorithms 167 are distinct from each other. In one embodiment forecasting algorithm tester 125 is configured to input the testing set of time series 165 into a plurality of candidate forecasting algorithms 167. Forecasting algorithm tester 125 is configured to cause each candidate forecasting algorithm to generate forecast values from the testing set of time series 165. Forecasting algorithm tester 125 is configured to determine forecasting errors 170 for the plurality of candidate forecasting algorithms 167 based at least on the values forecast by the candidate forecasting algorithms 167 and the actual values of the testing set of time series 165. The candidate forecasting algorithms 167 are candidates or options from among which one or more algorithms may be selected for monitoring time series.

In one embodiment, ranking function trainer 130 is configured to train a ranking function 175 to assign ranks to the candidate forecasting algorithms 167 based on a vector of characteristics. In one embodiment, the ranking function 175 is a machine learning model, such as a classification model, for classifying a forecasting algorithm as having a given rank among the candidate forecasting algorithms 167 for accuracy in forecasting a time series with the characteristics provided in the vector. In one embodiment, the ranking function is a machine learning model, such as a regression model, for estimating an accuracy of a forecasting algorithm in forecasting a time series with the characteristics provided in the vector. In one embodiment, ranking function trainer 130 trains a machine learning model to determine ranks of forecasting algorithms for forecasting a given time series based on a set of the N characteristics for the given time series. The ranking function trainer trains the machine learning model based on the ranks assigned to the candidate algorithms for a time series and the N characteristics for the time series (145 or 160).

In one embodiment, forecasting algorithm selector 135 is configured to automatically select one of the forecasting algorithms to monitor an additional time series based on a rank assigned by the ranking function for N characteristics of the additional time series 180. In other words, forecasting algorithm selector 135 is configured to select one algorithm of the candidate forecasting algorithms 167 to generate predictions for the given time series. The selected algorithm 185 is chosen based on at least the ranks assigned to the candidate algorithms 167 by the trained ranking function 175 that is provided with the N characteristics of the additional time series 180 as inputs.

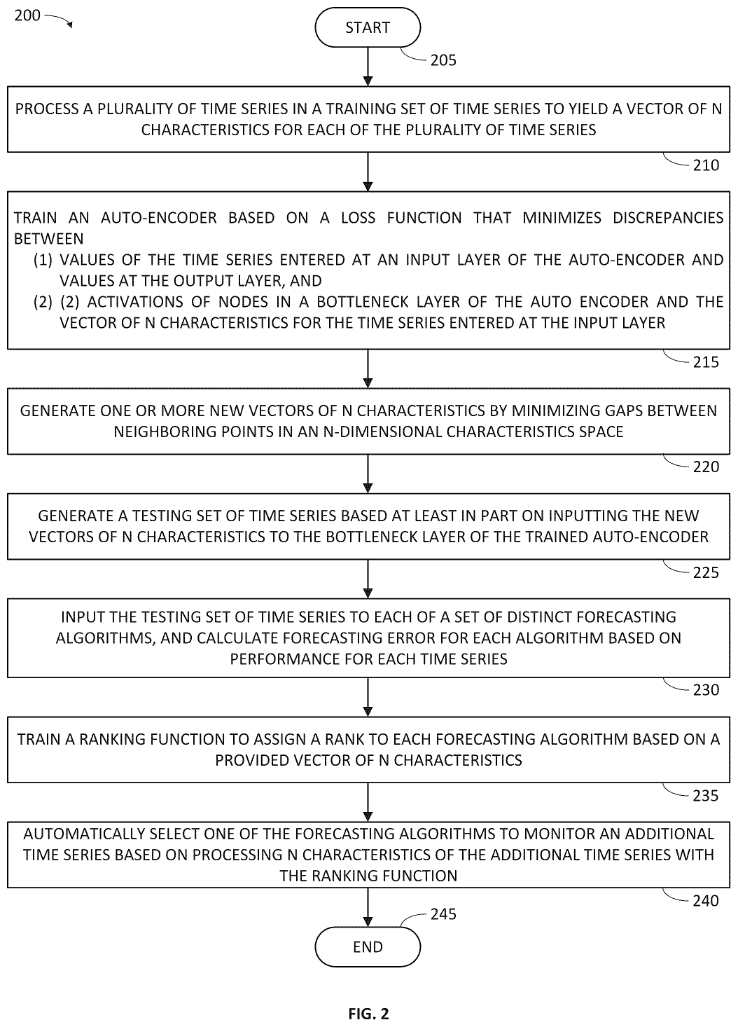

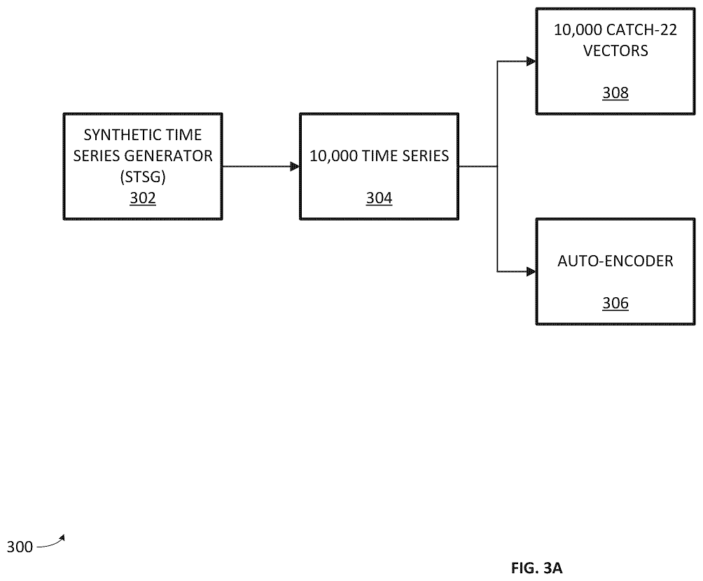

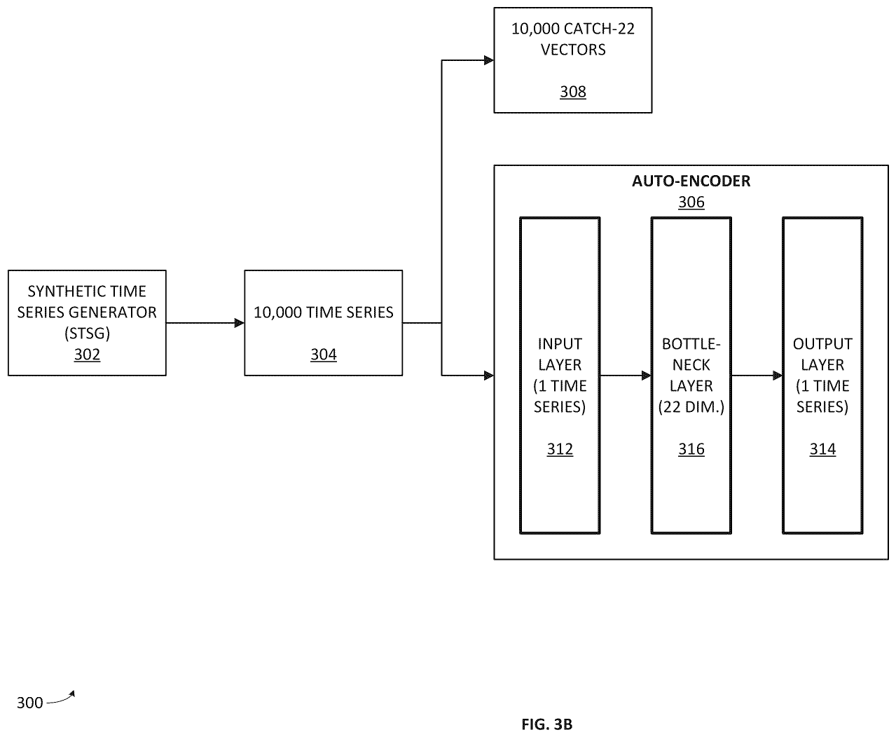

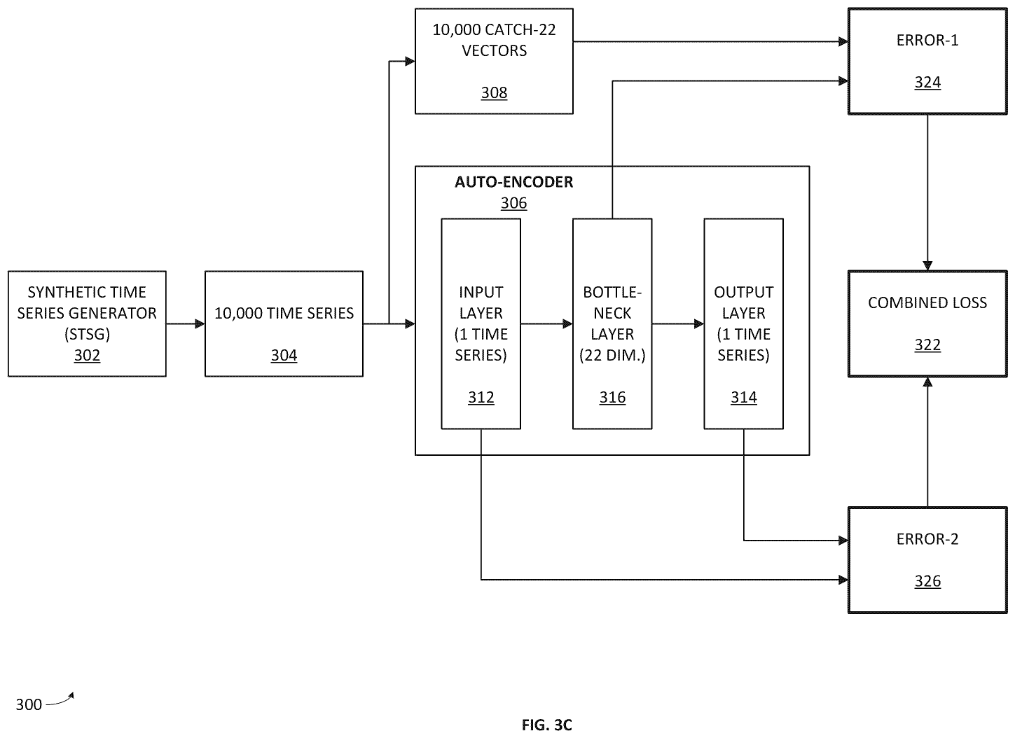

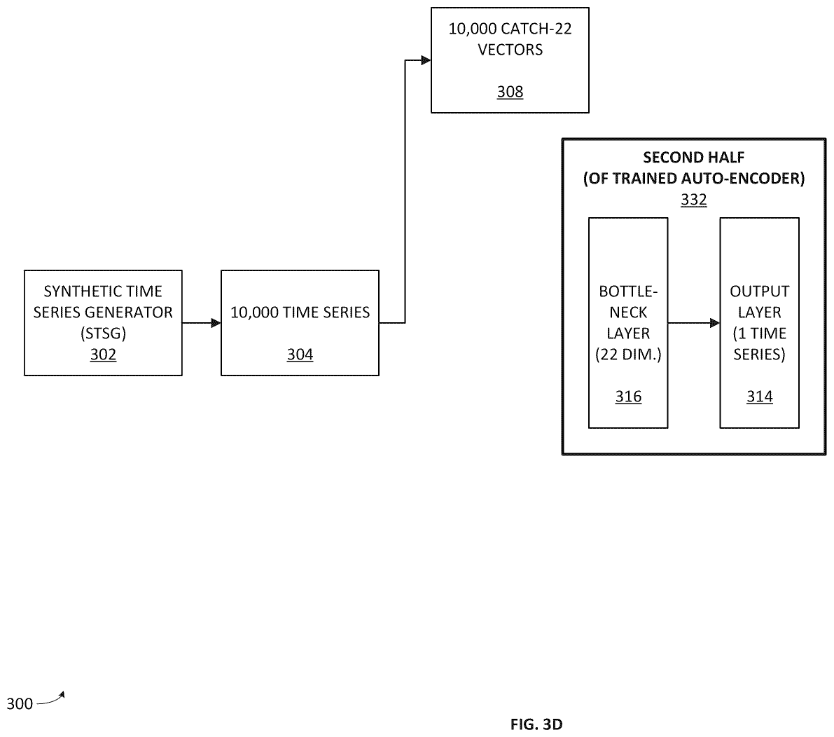

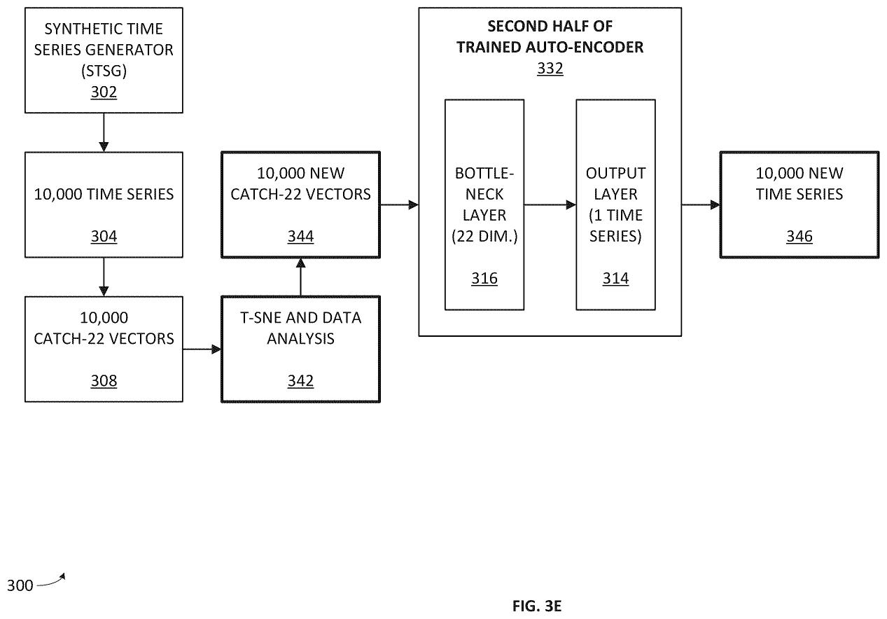

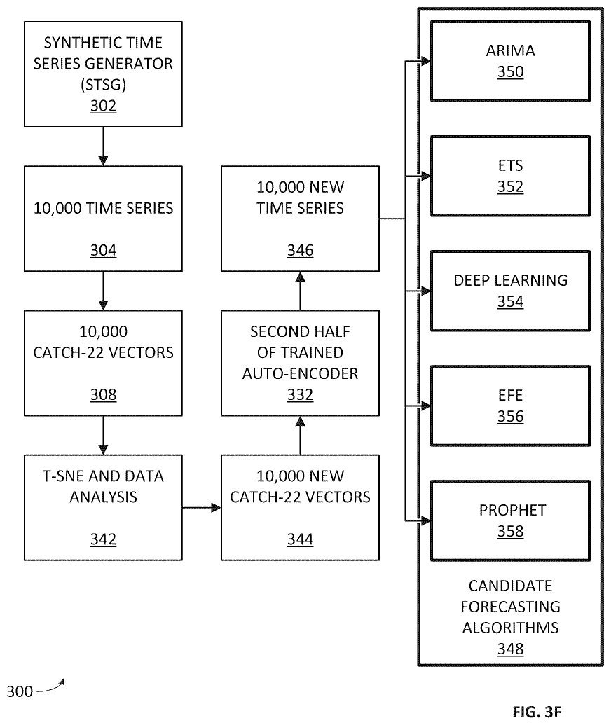

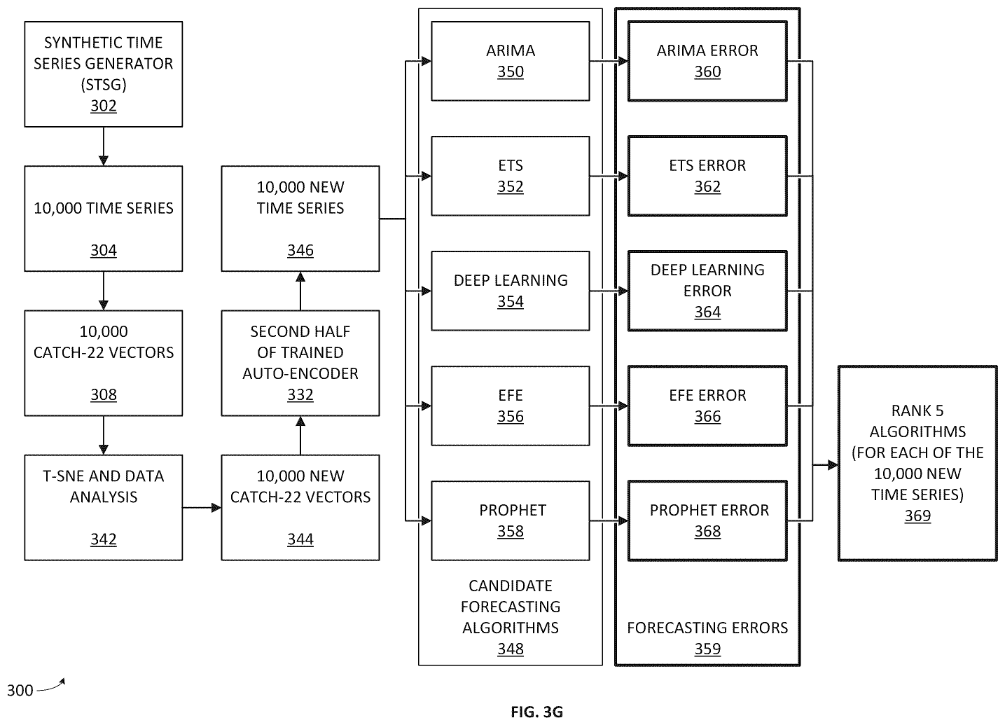

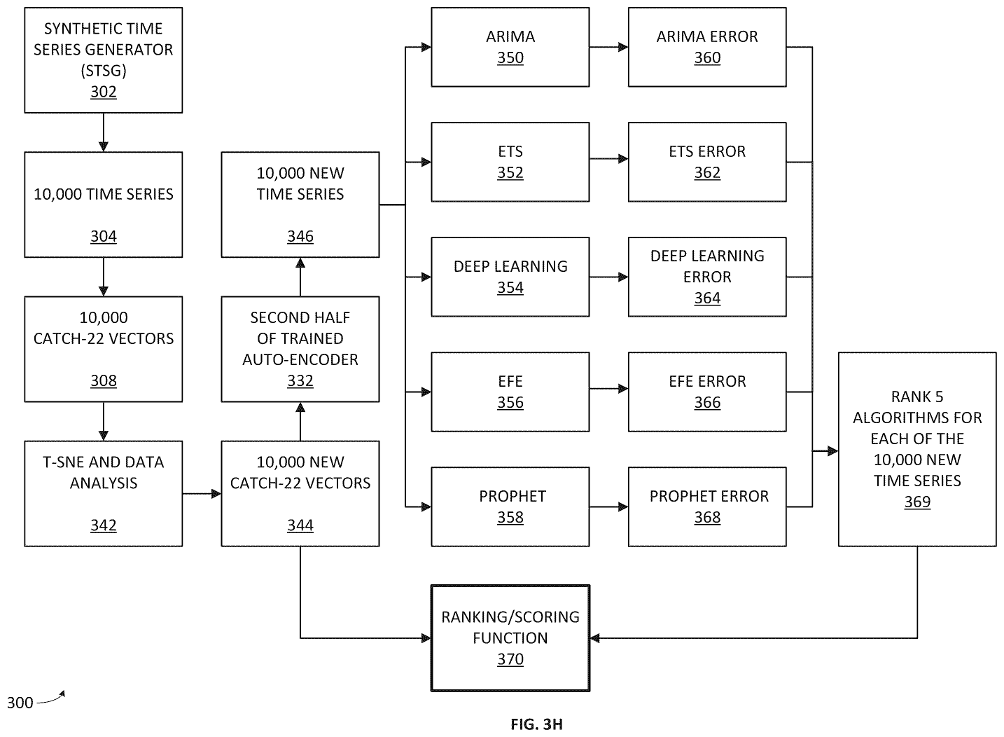

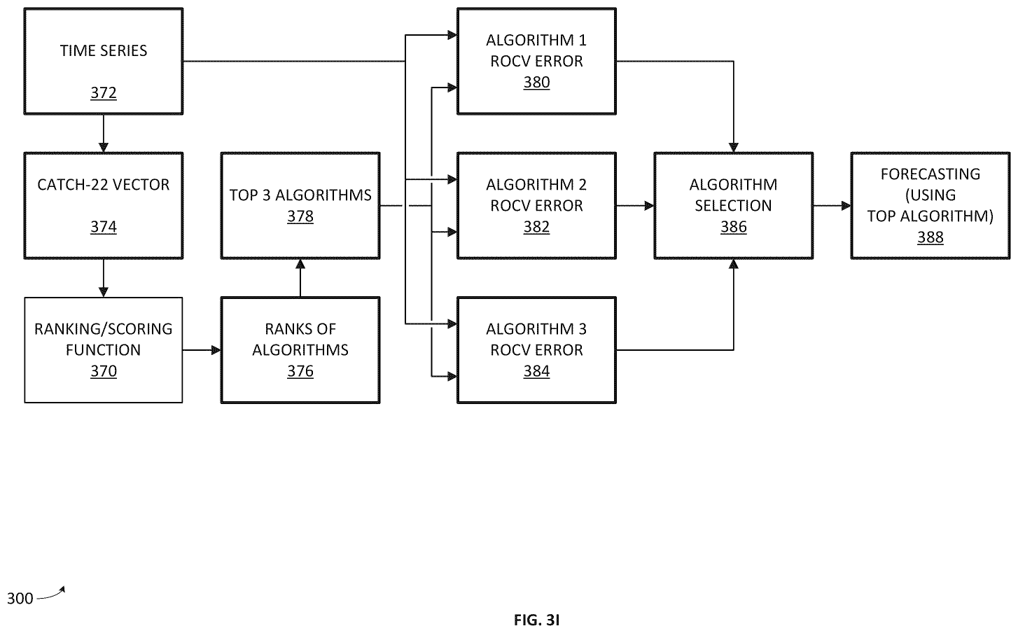

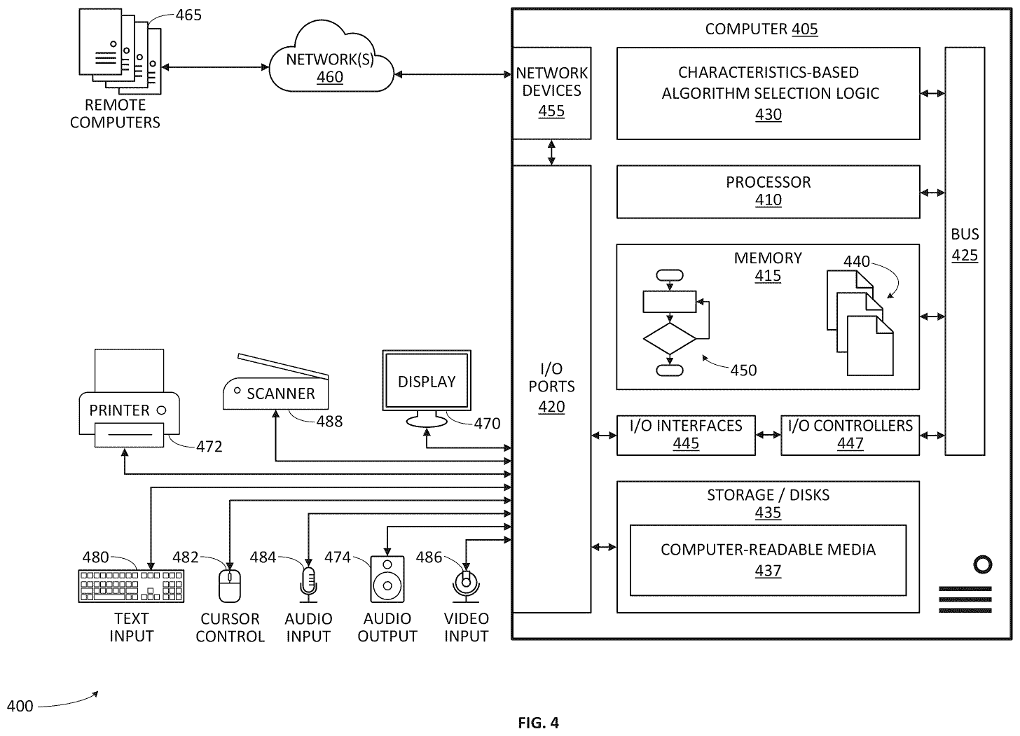

Further details regarding algorithm selection system 100 are presented herein. In one embodiment, operation of algorithm selection system 100 will be described with reference to method 200 of FIG. 2. In one embodiment, operation of algorithm selection system 100 will be described with reference to workflow 300 of FIGS. 3A-31, showing an automated, incremental construction of a forecasting algorithm selector.

### Example Algorithm Selection Method

FIG. 2 illustrates one embodiment of an algorithm selection method 200 associated with characteristics-based selection of time series forecast algorithms. Algorithm selection method 200 is one example process by which a machine learning model may be trained to determine which forecasting algorithms are most appropriate for a time series based on the characteristics of the time series. In one embodiment, algorithm selection method 200 includes steps for determining suitability of a particular type of forecasting algorithm (or forecasting model) for predicting values of a time series that exhibits a given profile of characteristics.

In one embodiment, as a general overview, algorithm selection method 200 analyzes individual time series in an initial set of time series to identify values for a set of characteristics that describe the individual time series. Algorithm selection method 200 then uses the time series and characteristics to train an auto encoder to have a bottleneck layer with activations that approximate the values of the characteristics, and an output layer with activations that approximates values of the time series. Algorithm selection method 200 also examines the particular characteristic values of the initial set of time series plotted into a space with a dimension for each characteristic, and finds a new collection of characteristics values that fill in gaps in the characteristics space. Algorithm selection method 200 then inputs these new characteristics values into the bottleneck layer of the trained auto encoder to generate supplemental time series that have the characteristics that were missing in the initial set of time series. These supplemental time series may be combined with the initial set of time series to form a testing set of time series that has dense coverage of the characteristic space. Algorithm selection method 200 then inputs the testing set of time series into various forecasting algorithms to determine the forecasting error for each forecasting algorithm. The algorithm selection method 200 thus relates the forecasting error of a forecasting algorithm when processing a time series with the characteristics of the time series. Algorithm selection method 200 uses the forecasting errors and associated characteristics of the time series to train a ranking function to assign a rank to each forecasting algorithm for monitoring a time series when provided with characteristics of the time series. With the trained ranking function, algorithm selection method 200 may automatically select a suitable one of the forecasting algorithms for monitoring a time series based on the characteristics of the time series.

In one embodiment, algorithm selection method 200 initiates at START block 205 in response to an algorithm selection system (such as algorithm selection system 100) determining one or more of (i) that an algorithm selection system has been instructed to create an automatic ranking function; (ii) that an algorithm selection system has been instructed to select a forecasting algorithm for monitoring a given time series; (iii) that an instruction to perform algorithm selection method 200 has been received (iv) a user or administrator of a resonance detection system has initiated algorithm selection method 200; (v) it is currently a time at which algorithm selection method 200 is scheduled to be run; or (vi) that algorithm selection method 200 should commence in response to occurrence of some other condition. In one embodiment, a computer system configured by computer-executable instructions to execute functions of algorithm selection system 100 executes resonance detection method 200. Following initiation at start block 205, resonance detection method 200 continues to block 210.

At block 210, algorithm selection method 200 processes a plurality of time series in a first or training set of time series to yield a vector of N characteristics for each of the plurality of time series. For example, algorithm selection method 200 may analyze each time series in a training set of time series to yield a vector of N characteristics for each of the time series. Thus, a characteristics vector of values for a set of characteristics or features that describe the behavior of data in a time series may be generated for each time series.

In one embodiment, algorithm selection method 200 accesses an initial set (also referred to as the first or training set) of time series. For example, the initial set of time series may be loaded from memory or storage, or provided by an STSG. The time series in the set will be used to train an auto-encoder, and may therefore be referred to herein as “training time series.” The training time series are each of a given length L, for example, L=1500 observations (or data points). The training set includes a count S of training time series that is sufficient for training the auto-encoder, for example, S=10,000 time series. Other numbers S for training time series may also be sufficient for training the auto-encoder, for example between 5,000 and 15,000 time series. The number of time series to be used for training is dependent on how low the threshold of the loss function is for indicating that the auto-encoder is trained.

The training time series exhibit diverse behaviors, for example, outliers, multiple seasonalities, differing change points in variance, level, trend, and/or seasonality, differing intermittencies, and differing high-level effects. The training time series may be synthesized to have these diverse behaviors, or the training time series may be real-world data that is confirmed to have the diverse behaviors. Where the time series data is synthesized, in one embodiment, the set of training time series are generated by a Synthetic Time Series Generator such as STSG 147. Synthetic generation of time series is discussed in further detail below, for example under the heading “Progression of STSG Generation of Initial Set of Time Series”.

While the training set is diverse, the time series in the training set may not uniformly cover the full ranges of the diverse behaviors that will be used for testing the suitability of particular types of forecasting algorithms/models. Accordingly, an auto-encoder-based time series generator may be created (as discussed at block 215 below). The auto-encoder-based time series generator is configured to produce supplemental time series based on a characteristics vector of N characteristics or properties that describe the supplemental time series. By augmenting or supplementing the characteristics vectors to fill gaps in the coverage of the characteristics (as discussed at block 220 below), the supplemental characteristics vectors may be used to generate extra time series using the auto-encoder. These extra time series flesh out the initial training set so that coverage of time series behaviors is more consistent.

In one embodiment, a characteristics vector function is executed on each training time series to generate, extract, or otherwise identify values for the N characteristics for each time series in the training set. Using the characteristics vector function, the values of the N characteristics for each training time series are determined by particular analyses that are specific to each characteristic. The characteristics vector function stores the values of the N characteristics as a vector of N values, with one value for each characteristic. This vector of characteristics values, or “characteristics vector” is a data structure including a set of N values that correspond to the N characteristics. The N characteristics describe features of an individual time series. In one embodiment, the characteristics are canonical characteristics that substantially express the behavior of a time series using a set of values for the characteristics of the time series. In one embodiment, collectively, the N characteristics compactly describe the behavior recorded by the time series. For example, the N characteristics may be the 22 “Catch 22” feature set (listed in Table 1 below).

In one embodiment, the activities of block 210 are carried out by characteristics analyzer 105. Additional detail regarding this characterization of time series by characteristics is provided below, for example with reference to FIG. 3A and under the heading “Specific Characteristics Used for Time Series Generation”.

At block 215, algorithm selection method 200 trains an auto-encoder based on a loss function. The loss function minimizes discrepancies between activations of nodes in a bottleneck layer of the auto encoder and the vector of N characteristics for the time series entered at an input layer of the auto-encoder (“Error-1”). And, the loss function also minimizes discrepancies between values of the time series entered at the input layer and values at an output layer of the auto-encoder (“Error-2”). More concisely, algorithm selection method, trains an auto-encoder using a loss function that minimizes error: (1) between bottleneck layer activations in the auto-encoder and the vectors of characteristics for the time series, and (2) between an input layer and an output layer of the auto-encoder. For example, the algorithm selection method 200 trains the auto encoder to cause values at the bottleneck layer to match values of the characteristics vector, and to cause values at the output layer to match values at the input layer. This training causes the second half of the auto-encoder from bottleneck layer to output layer to convert characteristics values into a time series that has the characteristic values.

An untrained auto-encoder has an input layer, an output layer, and an internal bottleneck layer. The input layer and output layer both include nodes for each observation (or position) in a training time series. In other words, the input layer and output layer both have L, e.g., 1500, nodes. The bottleneck layer has N nodes (e.g., N=22). For example, the bottleneck layer comprises N nodes that correspond to N characteristics of the input time series. In the auto-encoder, the input time series is reduced from L activation values at the input nodes (one value for each observation), to N activation values at the bottleneck nodes (one value for each characteristic), and then restored again to L activation values at the output nodes.

The auto-encoder-based time series generator is created based on the training time series, and the characteristics of each time series. The auto-encoder is then trained so that the N activation values of the nodes at the bottleneck match (or closely approximate) the N characteristics for each training time series, and the L activation values of the nodes at the output match (or closely approximate) the L activation values of the nodes at the input. This is based on a loss function configured to minimize the combined errors at the bottleneck layer and at the output layer. The error at the bottleneck layer is the discrepancies between the N actual characteristic values for an input time series and the N activation values of the N nodes in the bottleneck layer. The error at the output layer is the discrepancies between the L actual values in the input time series and the L activation values of the L nodes in the output layer.

In one embodiment, the loss function is a combined loss function that includes a weighted sum of the two measures of discrepancies, Error-1 and Error-2 above. In one embodiment, the two discrepancy terms are weighted equally, for example with weights of 0.5 applied to each. In one embodiment, the errors are collective discrepancies between the groups of values being compared. For Error-1, the error is the collective discrepancies between the N values of node activations in the bottleneck layer and the N values of characteristics corresponding to those nodes that are produced by a characteristics analysis of the input time series. For Error-2, the error is the collective discrepancies between the L values of the time series at the input layer of the auto-encoder and the L values of the corresponding observations in the estimate time series at the output layer of the auto-encoder. In one embodiment, Error-1 and Error-2 may be measured as the mean absolute scaled error (MASE), mean squared error (MSE), or mean absolute error (MAE) of the discrepancies.

Once the auto encoder has been trained, the auto-encoder can then be used to generate additional time series based on inputs of N characteristics at the bottleneck layer. An N-value vector of desired characteristics for a time series may be input to the bottleneck layer of the trained auto encoder, and the trained auto-encoder will generate a time series having the desired characteristics at the output layer. The bottleneck layer may be set or otherwise designated as an input to the trained auto encoder. For example, the layers preceding the bottleneck layer may be pruned away from the auto encoder. And, nodes of the bottleneck layer are activated to an extent indicated by values for the nodes given by an input characteristics vector. Based on input of a vector specifying N values for the characteristics, the second half of the trained encoder will output a time series of length L that exhibits the specified values of the characteristics.

The auto-encoder accepts the time series at an input layer having as many nodes as the length of the time series, constrains the input through a bottleneck layer having as many nodes as the number of characteristics, and produces output at an output layer having as many nodes as the length of the time series. The loss function used in training causes the bottleneck layer activations to closely approximate the values of the characteristics, and the output layer activations to closely approximate the time series values provided at the input layer.

Thus, in one embodiment, algorithm selection method 200 creates a time series generator from an initial set of time series as follows. Algorithm selection method 200 accesses the initial set of time series (for example as discussed at block 210 above) Algorithm selection method 200 identifies N characteristics of each time series of the first set of time series (for example using the characteristics vector function as discussed at block 210). Algorithm selection method 200 trains an auto-encoder with a bottleneck layer of N nodes-based on a loss function that minimizes discrepancies between bottleneck layer activations and the N characteristics (as discussed at block 215). And, algorithm selection method 200 sets the bottleneck layer as an input to the time series generator (as discussed at block 215). In one embodiment, the activities of block 215 are carried out by auto-encoder trainer 110. Additional detail regarding auto-encoder training is provided below, for example with reference to FIGS. 3B-3D.

At block 220, algorithm selection method 200 generates one or more new vectors of N characteristics by minimizing gaps between neighboring points in an N-dimensional characteristics space. For example, algorithm selection method 200 determines gaps in an N-dimensional characteristic space for the initial set of time series. The algorithm selection method 200 thus determines where coverage of the characteristics is sparse among a plurality of time series in the initial set of time series.

The characteristics of a training vector may be plotted in an N-dimensional space, which may also be referred to as a characteristics space. The characteristics of each training time series in the training set may be plotted into the characteristics space. Where there is inadequate representation of given behaviors in the training set, there will be gaps or sparsely populated areas in the characteristics space. Additional characteristics vectors are generated to supplement and fill gaps in the characteristics space for the initial set of time series. In this way, time series with characteristics that were unrepresented or underrepresented are now included in these characteristics vectors. The trained auto-encoder will be used to generate time series to represent those underrepresented behaviors based on values for the characteristics that fill or close up the gaps, as discussed below at block 225.

In one embodiment, the gaps are identified by reducing the N-dimensional plot to a two-dimensional plot (or other lower dimension plot such as a 3D plot) and then highlighting sparse regions in the two-dimensional plot. In one embodiment, the plot in the N-dimensional characteristics space is reduced to two dimensions by t-distributed stochastic neighbor embedding (t-SNE), or another suitable nonlinear dimensionality reduction technique. Sparse regions are then identified by using distance metrics to measure local densities of the dimensionally reduced plot. For example, a high Euclidean distance to nearest neighbors of a point indicates that a low-density or sparse regions surrounds the point. Or, for example, areas that are considered to be noise in density-based spatial clustering of applications with noise (DBSCAN) may be considered to be a sparse region. And highlighting sparse regions may also be based on other metrics, including kernel density estimation (KDE), local outlier factor (LOF) detection algorithm, and Gaussian mixture modeling (GMM).

With the sparse regions (gaps) identified, algorithm selection method 200 generates new sets of N characteristic values that will occur in the sparse regions. In one embodiment, new points in sparse regions are generated by placing points between the existing points by interpolation, such as linear interpolation or spline interpolation. Or, in one embodiment, generating new characteristic data points to in-fill the sparse regions may also be performed by averaging the N characteristics values of neighboring data points to produce a new point. In one embodiment, the new points are placed between two points in the sparse region of the N-dimensional characteristics space. In one embodiment, S (e.g., 10,000) new sets of N characteristic values are generated.

Thus, in one embodiment, algorithm selection method 200 reduces the plot of characteristics from N dimensions to 2 dimensions by t-SNE, identifies sparse regions in the 2-dimensional plot of the characteristics by finding regions of relatively high Euclidean distance between neighboring points, and generating new characteristics data points in the sparse regions by averaging the characteristics values of neighboring points. Using the bottleneck layer as an input layer thus allows generation of an additional set of time series (as discussed at block 225 below) from characteristic vectors that are selected to minimize gaps between two nearest points in the N-dimensional characteristics space. In one embodiment, the activities of block 220 are carried out by gap filler 115. Generation of new vectors of characteristics is discussed further below, for example with respect to of FIG. 3E.

At block 225, algorithm selection method 200 generates a testing set of time series based at least in part on inputting the new vectors of N characteristics to the bottleneck layer of the trained auto-encoder. For example, algorithm selection method 200 generates a second or testing set of time series at least in part by inputting characteristics vectors that fill the gaps into the bottleneck layer to generate further time series that have the input characteristics. The set of these further time series that have the input characteristics that fill the gaps may therefore also be referred to as a gap-filling set of time series. In one embodiment, algorithm selection method 200 inputs one or more characteristics vectors that fill the gaps into the bottleneck layer to produce a gap-filling set of time series. In one embodiment, the testing set of time series includes the initial set and the further time series generated by the time series generator from the characteristics vectors that fill the gaps in the characteristics space.

In one embodiment, the algorithm selection method 200 inputs the S new characteristic vectors (sets of characteristic values) that were generated at block 220 above into the bottleneck layer of the trained auto encoder. As discussed in further detail herein, the auto-encoder has been trained so that activating characteristics nodes at the bottleneck layer will cause the auto-encoder to generate a time series at the output. In response to the input of the S new characteristic vectors, S new time series are generated by the trained auto-encoder. Thus, in one embodiment, using the bottleneck layer as an input layer allows generation of a gap-filling set of time series from characteristic vectors that are selected to minimize gaps between two nearest points in the N-dimensional characteristic space. The generated gap-filling set of time series may therefore be considered to be gap-based because the gap-filling time series that make up the gap-filling set of time series have characteristics that fill in sparse regions of the characteristics space.

In one embodiment, the S new time series are appended to or inserted into the training set to produce a testing set of time series signals. For example, the testing set would then include 2×S time series signals. Thus, in one embodiment, algorithm selection method 200 combines the training set (that is, the initial or first set) of time series with the gap-filling set of time series to generate a combined set of time series as the testing set. In one embodiment, the S new time series signals are used as the testing set without including the training set.

Thus, in one embodiment, the algorithm selection method 200 accesses the trained auto encoder. For the S new characteristic vectors, the algorithm selection method 200 sets the activations of the N nodes in the bottleneck layer to the values of the N characteristics that correspond to the nodes, executes the trained auto-encoder through to the output layer, and stores the activations of the L nodes in the output layer as a new time series data structure that is L observations in length, thereby generating and storing S additional time series. In one embodiment, each new time series may be stored in association with the values of the N characteristics input at the bottleneck layer to cause the generation of the new time series. In one embodiment, the activities of block 225 are carried out by characteristics-based time series generator 120. Creation of the testing set is also discussed below with reference to FIG. 3E.

At block 230, algorithm selection method 200 inputs the testing set of time series to each of a set of distinct forecasting algorithms, and calculates forecasting error for each algorithm based on performance for each time series. As discussed below at block 240, these distinct forecasting algorithms will be candidates for selection to monitor an additional time series. In one embodiment, the algorithm selection method 200 inputs the combined set of time series into a plurality of candidate forecasting algorithms, and each candidate forecasting algorithm is configured to generate forecast values from the combined set of time series in response to the input. Thus, in one embodiment, algorithm selection method 200 tests the accuracy of the candidate forecasting algorithms. Algorithm selection method 200 inputs the testing set of time series into a plurality of candidate forecasting algorithms. Algorithm selection method 200 executes each candidate forecasting algorithm to generate forecast values from the combined set of time series. Algorithm selection method 200 then determines forecasting errors for the plurality of candidate forecasting algorithms based at least on the forecast values and the combined set of time series.

The test set of time series signals is thus used to evaluate the suitability of various types of forecasting model for processing time series that exhibit particular characteristics. The time series signals in the testing set are provided individually to each of a set of F forecasting algorithms that are candidates for selection. In one embodiment, there are F=5 forecasting algorithms: autoregressive integrated moving average (ARIMA) model, an error-trend-seasonality (ETS) model, deep learning, error feedback estimation (EFE) model, and prophet model. The forecasting error between a test time series signal and the forecast is found for each of the F algorithms. In one embodiment, the forecasting error may be the mean absolute scaled error (MASE), mean squared error (MSE), or mean absolute error (MAE) over the length of the test time series signal.

The forecasting error for each of the F forecasting algorithms is stored in association with the characteristic values for the test time series. For example, the characteristic values and forecasting errors may be stored in a vector of length N+F. At the end of testing, the performance (measured by forecasting error) for each type of forecasting model is associated with the characteristics of the time series that was being forecast.

Thus, in one embodiment, algorithm selection method 200 generates a measurement of the performance of each candidate forecasting algorithm on each time series signal in the testing set. For each forecasting algorithm, algorithm selection method 200 compares the original test time series to the predictions generated by a forecasting algorithm to measure differences (residuals), and then calculates a value for error (e.g., MASE) from the differences. The errors of the various candidate algorithms for a time series are then stored in association with the characteristics of the time series. In one embodiment, the activities of block 230 are carried out by forecasting algorithm tester 125. Evaluation of the forecasting algorithms is also discussed below with reference to FIGS. 3F and 3G.

At block 235, algorithm selection method 200 trains a ranking function to assign a rank to each forecasting algorithm based on a provided vector of N characteristics. For example, algorithm selection method 200 trains a machine learning model to determine ranks of forecasting algorithms for forecasting a given time series based on the forecasting errors and the N characteristics. In one embodiment, a machine learning model is trained to automatically rank the accuracy of the candidate forecasting models for monitoring a given time series on input of the N characteristics that describe the given time series.

Here, the training of the ranking function (machine learning model) is based on the forecasting errors and the N characteristics for the training set of time series. Once the ranking function is trained, the ranking function will determine the ranks of the forecasting algorithms for forecasting a given time series based on input of a set of the N characteristics for the given time series.

In one embodiment, the ranking function includes an ML regression model to estimate a forecasting error for the F forecasting algorithms given the N characteristics and a sorting function to sort the resulting regression estimates by rank. The regression model is configured to generate estimated forecasting errors for each of the F forecasting algorithms that are consistent with the performance of the F forecasting algorithms on the testing set of time series signals. The sorting function is configured to sort the F forecasting algorithms in ascending order of estimated forecasting error, and label the forecasting algorithms with ranked order.

In one embodiment, the ranking function includes a sorting function to sort the F forecasting algorithms in ascending order of actual forecasting error and label the F forecasting algorithms with ranked order, and a ML classification model to estimate ranks for the F forecasting algorithms given the N characteristics. The classification model is configured to generate estimated ranks for each of the F forecasting algorithms that are consistent with the actual ranks, by forecasting error, of the F forecasting algorithms.

In one embodiment, once trained, the ranking function accepts vectors of the N characteristics, and produces ranks of the F forecasting models from most suitable to least suitable (based on estimated forecast error) for processing a particular time series with given values for the N characteristics. In one embodiment, the activities of block 235 are carried out by ranking function trainer 130. The training of the ranking function is further discussed below with reference to FIG. 3H.

At block 240, algorithm selection method 200 automatically selects one of the forecasting algorithms to monitor an additional time series based on processing N characteristics of the additional time series with the ranking function.

For example, algorithm selection method 200 selects one algorithm of the candidate forecasting algorithms to generate predictions for a given time series based on at least the ranks.

In one embodiment, the selection is based on respective cross-validation (ROCV) errors between the cross-validation of the particular time series and cross-validation of the F forecasting algorithms. In one embodiment, the respective cross-validation error is found only for a subset F′ of the F forecasting algorithms that have least values for estimated forecast error. In other words, the subset F′ includes a top few of the F forecasting algorithms. The algorithm that has the least ROCV is selected as the top-ranked forecasting algorithm. The top-ranked forecasting algorithm may then be deployed to monitor the particular time series on an ongoing basis.

In one embodiment, algorithm selection method 200 automatically select one of the forecasting algorithms to apply to use to monitor the additional time series. Algorithm selection method 200 assigns ranks to the forecasting algorithms with the trained ranking function. The ranks are assigned based on a N-dimensional vector of the characteristics for the additional time series. Once the ranks are assigned, the algorithm selection method 200 selects a plurality of top-ranked algorithms from the forecasting algorithms. In one embodiment, the top three forecasting algorithms are selected. Algorithm selection method 200 then calculates the respective cross-validation errors of the top-ranked algorithms with respect to the additional time series. And, algorithm selection method 200 selects to be the one of the forecasting algorithms the top-ranked algorithm with the least respective cross-validation error. In one embodiment, the activities of block 240 are carried out by forecasting algorithm selector 135. Automated selection of a forecasting algorithm based on a characteristics profile of a time series to be monitored is discussed further below with reference to FIG. 3I. At the completion of block 240, algorithm selection method 200 proceeds to END block 245 where algorithm selection method 200 concludes.

The selected algorithm is then automatically used to monitor the additional time series. The steps of method 200 operate to automatically choose, based on particular characteristics of a given time series, an algorithm that has best performance for monitoring the given time series.

### Further Embodiments of Example Algorithm Selection Method

In one embodiment, following the conclusion of block 240, algorithm selection method 200 further includes steps to predict the values of the additional time series and issue alerts where the actual values deviate from the predictions. For example, algorithm selection method 200 proceeds to forecast values of the additional time series with the selected forecasting algorithm. And, algorithm selection method 200 generates an alert where the forecast values differ from actual values of the additional time series. (Detection of anomalous differences and electronic alerting are discussed in further detail below under the heading “Detection of Anomalous Deviation and Electronic Alerts”).

In one embodiment of algorithm selection method 200, the bottleneck layer (discussed at block 215 above) includes N nodes that correspond to N characteristics in the vector of N characteristics. For example, the bottleneck layer has 22 nodes that correspond to 22 characteristics of the time series. In one embodiment, the 22 nodes correspond in a one-to-one manner to the 22 “catch-22” characteristics of the time series described below.

In one embodiment of algorithm selection method 200, the time series in the initial set of time series (introduced in block 210 above) are synthesized to simulate a range of time series behaviors comprising outliers, multiple seasonalities, change-points, intermittency, and high-level effects.

In one embodiment of algorithm selection method 200, the loss function (discussed at block 215 above) is configured to minimize discrepancies between the bottleneck layer activations and the characteristics vectors by evaluating a combined error of a) a difference between output and input, and b) a difference between the bottleneck layer and the characteristic features of the first set of time series.

In one embodiment of algorithm selection method 200, using the bottleneck layer as an input layer allows generation of the combined set (or testing set) of time series from characteristic vectors that are selected to minimize gaps between two nearest points in the N-dimensional characteristics space (as discussed at blocks 220-225 above).

In one embodiment of algorithm selection method 200, the candidate forecasting algorithms comprise one or more of an autoregressive integrated moving average (ARIMA) model, an error-trend-seasonality (ETS) model, a deep learning model, an error feedback estimation (EFE) model, and a prophet model (as discussed at block 230 above).

In one embodiment of algorithm selection method 200, the analysis of each time series to yield a vector of N characteristics (discussed at block 210) generates the vector to include catch-22 characteristics. Thus, in one embodiment, the N characteristics of each time series of the first set of time series include a plurality of characteristics selected from the following characteristics: mode of z-scored distribution, longest period of consecutive values above the mean, time interval between successive extreme events above the mean; time interval between successive extreme events below the mean, first l/e crossing of an autocorrelation function, the first minimum of the autocorrelation function, total power in a lowest portion of frequencies in a Fourier power spectrum, centroid of the Fourier power spectrum, mean error from a rolling multi-sample mean forecasting, a time reversibility statistic, automutual information, first minimum of an automutual information function, proportion of successive differences exceeding a given coefficient of the standard deviation, longest period of successive incremental decreases, Shannon entropy of two successive letters in equiprobable 3-letter symbolization, changes in correlation length after iterative differencing, and exponential fit to successive distances in 2D embedding space. In one embodiment, the analysis generates the vector to include a full set of the catch-22 characteristics.

In one embodiment of algorithm selection method 200, the initial (or training) time series (introduced in block 210) are each of a same length. In one embodiment, the additional time series generated by the auto-encoder to produce the testing set of time series may also be of the same length as the initial time series. In one embodiment, the length of each time series in the training set and testing set is equal. The length is sufficient to convey the behaviors of the time series to a machine learning model in a training process. Thus, in one embodiment training time series and testing time series are of an equal length that is between 1000 and 2000 observations. For example, the training time series and testing time series may be 1500 observations in length.

In one embodiment, the automatic selection of one of the forecasting algorithms (at block 240) evaluates the most accurate of the forecasting algorithms for overfitting using respective cross-validation errors, automatically selecting the least overfitted algorithm from among the most accurate (as discussed below with reference to FIG. 3I). In one embodiment, algorithm selection method 200 assigns ranks to the forecasting algorithms with the trained ranking function based on a N-dimensional vector for the additional time series. Algorithm selection method 200 selects three top-ranked algorithms from the forecasting algorithms. Algorithm selection method 200 calculates the respective cross-validation errors of the top-ranked algorithms with respect to the additional time series. And, algorithm selection method 200 selects, to be the one of the forecasting algorithms, the top-ranked algorithm with the least respective cross-validation error.

In one embodiment, the minimization of gaps between neighboring points in an N-dimensional characteristics space (discussed at block 220) is performed based on t-distributed stochastic neighbor embedding.

### Discussion and Additional Embodiments

In one embodiment, the algorithm selection systems and methods described herein address the complex issue of selecting a forecasting algorithm for time series forecasting by employing a flexible, inclusive strategy. This improvement promotes cross-industry applications, given the algorithm selection system proficiency in managing time series data from diverse industries, domains, or functions.

Two prominent strategies for algorithm selection are recognized in both industry and academia: a brute force approach, and previous meta-learning methods such as FFORMS. The brute-force approach involves applying all available algorithms to the dataset in question to discern the most effective. However, this approach is notably resource-intensive. Earlier meta-learning methods, such as FFORMS, are a somewhat more resource-efficient strategy that builds a classifier or rank function using well-known public datasets (such as M3, M4, M5, and/or Kaggle). Yet, the existing meta-learning methods only perform satisfactorily with datasets from domains that the meta-learning method has encountered during the training phase.

The algorithm selection systems and methods described herein overcome these challenges by providing a new meta-learning method that abandons the use of public data sets, and leverages synthetically generated time series data sets, canonical features of the time series, and auto-encoder machine learning to ensure training coverage over all domains for the machine learning tool that makes the selection of the forecasting algorithms. This expands the applicability and versatility of automated forecasting algorithm selection.

Therefore, in one embodiment, the algorithm selection system implements a domain-agnostic approach for developing a time-series forecasting algorithm. In one embodiment, the algorithm selection system provides a comprehensive approach to time series forecasting that combines synthetic data generation, autoencoder-based feature representation, and adaptive algorithm selection, all within a domain-agnostic framework. This combination of techniques results in a highly versatile and efficient forecasting solution.

In one embodiment, the algorithm selection system employs synthetic time series generation to ensure broad coverage of domains of time series activity. For example, the algorithm selection synthesizes an initial set of time series using a synthetic time series generator (STSG). The use of a STSG allows for the creation of diverse time series data that incorporate a wide range of behaviors, making the resulting models more adaptable to various scenarios and time series characteristics. This aspect is an improvement over prior techniques which were limited to specific domains of time series activity, and were therefore not domain-agnostic.

In one embodiment, the algorithm selection system implements auto-encoder-based feature representation. In one embodiment, the algorithm selection system employs an auto-encoder to capture the catch-22 features (or characteristics) of the time series. Such use of the auto-encoder enables a compact and efficient representation of the input time series data, thereby facilitating the identification of gaps in the 22-dimensional vector space and allowing for improved forecasting performance. This aspect is an improvement over prior techniques which could not identify where the body of time series lacked certain characteristics, and which could not automatically generate time series from provided characteristics to supplement or enhance the body of time series.

In one embodiment, the algorithm selection system leverages comprehensive coverage of a 22-dimensional catch-22 vector space. In one embodiment, the algorithm selection systems and methods ensure that an entire 22-dimensional catch-22 vector space is covered. This allows the algorithm selection system to choose a forecasting algorithm to handle time series data from any domain, making the algorithm selection system highly versatile and robust. This aspect is an improvement over prior techniques which may make poor selections of forecasting algorithms for time series that have characteristics in un-covered areas of the catch-22 vector space.

In one embodiment, the algorithm selection system performs algorithm ranking and selection to choose from among a plurality of candidate forecasting algorithms. By ranking various forecasting algorithms based on their performance in relation to the catch-22 features of the input time series, the proposed method can adaptively choose the most suitable algorithm for a given task, resulting in more accurate forecasting results. This aspect is an improvement over prior techniques which did not consider how well a particular forecasting algorithm in comparison with alternative algorithms.

In one embodiment, the algorithm selection system is a domain-agnostic approach to forecasting algorithm selection. The algorithm selection system functions across different domains, allowing for a more generalizable solution in time series forecasting. In one embodiment, the generalizability is achieved by comprehensively covering the 22-dimensional catch-22 vector space in the set of time series used for testing accuracy of the forecasting models, ensuring the selected model's adaptability to various types of time series data.

In one embodiment, the algorithm selection system operates a STSG to simulate a wide range of time series behaviors, including outliers, multiple seasonalities, change-points (variance, level, trend, seasonality), intermittency, and high-level effects. Then, the algorithm selection system trains an auto-encoder on numerous synthetic time series produced by the STSG. A bottleneck layer of the auto-encoder comprises 22 nodes, while the input layer and output layer have 1500 nodes. The loss function evaluates the combined error of: (a) the difference between the output and input of the auto-encoder; and (b) the difference between the bottleneck layer and the catch-22 features of the time series. The algorithm selection system visualizes or projects the catch-22 features of the input time series data on a 2D canvas in order to pinpoint areas in the 22-dimensional vector space that lack input time series.

The algorithm selection system employs the second half of the autoencoder, using the bottleneck layer as the input layer, to process a sufficient number of synthetically constructed catch-22 vectors to ensure that no large gaps exist between two nearest points in the 22-dimensional vector space. The output of inputting these constructed vectors into the bottleneck layer is then utilized for testing the accuracy of various distinct forecasting algorithms. The algorithm selection system applies the various distinct forecasting algorithms to the output time series from the previous step and records the respective forecasting errors (such as MASE) for the forecasting algorithms.

The algorithm selection system then ranks the algorithms for each time series and trains a ranking function that assigns a rank to each algorithm based on the given 22-dimensional characteristics vector representing the input series. The algorithm selection system then implements a versatile forecasting algorithm selector. The forecasting algorithm selector is, in one embodiment, applicable to any domain because it encompasses the entire 22-dimensional vector space to generate time series that are subsequently input into the forecasting algorithms.

### —Progression of STSG Generation of Initial Set of Time Series—

In one embodiment, the algorithm selection system commences with synthesizing an initial set of time series, for example using an STSG. The initial set of time series synthesized by an STSG may be used both in training the auto-encoder and, once supplemented with further time series that fill in gaps of the characteristics space, in training the forecast model ranking function. In one embodiment, the progression of synthetic time series dataset generation evolves through several stages: —Stage 0: baseline model; stage 1: enriched model; stage 2: meta-enhanced model; stage 3: dynamic model; and stage 4: near-real model.

The stage 0, baseline model stage focuses solely on primary data. This represents an initial state of synthetic time series dataset generation.

The stage 1, enriched model stage is characterized by incorporating additional data, amplifying the complexity of the primary dataset, and embedding a broader range of contextual elements. In one embodiment, a time series is postulated to be an amalgamation of a base value (for each observation of the time series) augmented by numerous factors, for example as shown in formula EQ. 1:

$$target = base\_value ⋆ factor 1 ⋆ factor 2 ⋆ … ⋆ factorN + Noise \qquad EQ . l$$

In one embodiment, at stage 1, three distinct factors are utilized:
1. a Weekday Factor which introduces the concept of time dependency, accounting for variations between weekdays and weekends within each series;
2. a Random Feature Factor which provides a random weightage to each series, adding an element of unpredictability to the synthetic data; and
3. a Sinusoidal Factor which is employed to instill a sense of seasonality in some series, reflecting cyclical trends often observed in real-world data.

These factors generate numerical coefficients to be integrated into the above formula, EQ. 1, assigning varying weights to produce or arrive at the target value.

At the completion of the stage 1, enriched model stage, the synthesized set of time series may be acceptable for use in training of the auto-encoder. However, further refinement of the time series at stage 2 may be desirable for producing more realistic time series.

The stage 2, meta-enhanced model stage integrates metadata into the pre-existing dataset. Integration of metadata into the dataset facilitates a more comprehensive understanding of data contexts and interconnections, thus enhancing the realism and relevance of the synthetic dataset. In one embodiment, the STSG employs a top-down methodology for generating synthetic time series data at the meta-enhanced model stage.

In the meta-enhanced model stage, the process commences with metadata, and logical columns such as brand, city, and state are created. Synthetic time series for each metadata column are then generated, for example using a library of functions for generating time series. The individual series generated represent variability of the time series data by location metadata. These individual series are combined through a weighted sum to produce a single time series.

For output calculation in the meta-enhanced model stage, the STSG incorporates three further factors:
1. a collection of Seven Distinct Seasonality Patterns which capture the seasonal variations and trends in the data;
2. a Weekend Boost Factor which incorporates the impact (if any) of weekends on the time series data; and
3. a Random Series Factor which provides an additional degree of randomness, reinforcing the unpredictability element.

The baseline formula therefore undergoes a modification in the meta-enhanced model stage as shown in EQs. 2 and 3:

$$target = base\_value ⋆ WeekdayFactor ⋆ randomSeriesFactor ⋆ Mean ( seasonality ) + Noise \qquad EQ . 2$$

$$Final Series = {Series}_{brand} ⋆ {Wt}_{brand} + {Series}_{city} ⋆ {Wt}_{city} + {Series}_{s tate} ⋆ {Wt}_{s t a t e} \qquad EQ . 3$$

(Note, in EQ. 3, each of the series-Series_{brand}, Series_{city}, and Seriesₛₜₐₜₑ—is generated using modified baseline EQ. 2.) This approach results in a synthetic dataset that better mirrors the complexity and dynamics of real-world data, setting the stage for more accurate and effective forecasting.

At the completion of the stage 2, meta-enhanced model stage, the synthesized set of time series may be acceptable for use in training of the auto-encoder. However, further refinement of the time series at stage 3 may be desirable for producing still more realistic time series.

The stage 3, dynamic model stage introduces dynamic elements-specifically, changepoints and intermittency-into the synthetic dataset. These additions emulate the unpredictability and non-linearity found in real-world data by accounting for abrupt changes and non-continuous data points, thereby injecting another layer of realism into the synthetic dataset. The dynamic model stage thus delves deeper into the complexity of data synthesis, focusing on capturing the sudden shifts, irregularities, and non-linear relationships often seen in real-world time series data.

In one embodiment, the processing at the dynamic model stage starts with the enriched dataset from the previous meta-enhanced model stage. The enriched dataset from the meta-enhanced model stage is further enhanced by the addition of two significant elements: changepoints and intermittency.

Changepoints are points in the time series where the data undergoes abrupt shifts. Four types of changepoints are introduced to simulate various aspects of real-world data. The four types of changepoints include (a) a Level Change changepoint which mimics sudden shifts in the baseline level of data; (b) a Trend Change changepoint which reflects abrupt changes in the data trend or slope; (c) a Seasonality Change changepoint which captures sudden shifts in the seasonal pattern; and (d) a Variance Change changepoint which represents changes in the data's volatility or spread. The inclusion of these diverse changepoints allows the synthetic data to exhibit the non-linear and unpredictable behavior that is often seen in real-world scenarios.

Intermittency refers to the sporadic, often unpredictable occurrence of events. By incorporating intermittency into the synthetic time series data, the synthesized time series mirror real-world situations where data is not continuously generated, or events do not occur at regular intervals.

Due to the non-linear nature introduced by the various types of changepoints, the baseline formula used in previous stages is not sufficient to represent the synthetic data at this stage. Instead, more advanced statistical models or machine learning techniques may be needed to capture the complex relationships in the data. The final synthetic time series now becomes a complex, non-linear combination of the individual series, each representing a unique piece of metadata, further modulated by changepoints and intermittency.

At the completion of the stage 3, dynamic model stage, the synthesized set of time series are acceptable for use in training of the auto-encoder. However, further refinement of the time series at stage 4 may be desirable for producing time series that closely mirror real-world data.

At the stage 4, near-real model stage the synthetic datasets are adjusted to introduce additional complexities and nuances that are present in real-world data. In this way, the synthetic time series datasets may become virtually indistinguishable from real-world datasets.

In one embodiment, the synthetic time series generation described herein may be performed by synthetic time series generator 147. The synthetic time series generation serves to provide diverse time series—that is, time series that exhibit a wide variety of characteristics. In one embodiment, the diversity of the synthesized time series ensures that both the time series and the characteristics vectors (e.g., catch-22 vectors) associated with the time series have distinct characteristics and encompass a wide range of behaviors.

### —Construction of Forecasting Algorithm Selector—

In one embodiment, FIGS. 3A-31 show an example of automated, incremental construction of a forecasting algorithm selector. A workflow 300 is shown in sequential stages of development into the forecasting algorithm selector in FIGS. 3A-31. Referring to FIG. 3A, in one embodiment, the construction initiates with using a Synthetic Time Series Generator (STSG) 302 to generate an initial set (or training set) of time series, for example 10,000 time series 304.

In one embodiment, the STSG 302 adeptly simulates diverse time series behaviors in the time series that STSG 302 generates. The simulated behaviors encompass outliers, multiple seasonalities, change-points, intermittency, and high-level effects. Outlier refers to data values in the time series that significantly differ from the patterns and trends of the other values in the time series. Seasonality refers to variations in the time series values that occur at regular intervals. Changepoint refers to positions in the time series where one or more statistical properties adjust abruptly. The change-points may include be with reference to variance, level, trend, seasonality, or other statistical properties. Intermittency refers to the observation of the time series data irregularly or sporadically over time, resulting in gaps in observations or irregularly spaced observations in the time series. High-level effects refers to broad or overarching patterns, phenomena, or factors that influence the behavior of a time series that are not specifically attributable to the other behaviors of the time series.

In workflow 300, STSG 302 produces an ample quantity of time series to be the initial set, such as 10,000 time series 304, which suffices for training an auto-encoder 306. In one embodiment, each time series in the initial set (of 10,000 time series 304) has a same length. For example, each time series may have a length of 1,500 observations. In this example, 1,000-2,000 observations is sufficient to capture the time series behaviors discussed above. If the time series behaviors extend over greater numbers of observations, the length of the time series may be expanded to encompass the behaviors.

Each synthetically generated time series undergoes processing by a characteristics function that identifies values for a pre-determined set of characteristics or properties of the time series, such as the 22 “catch-22” characteristics listed below. For each time series, the characteristics function produces a characteristics vector that includes a value of each of the set of N characteristics of the time series, such as 10,000 catch-22 vectors 308. For example, where the characteristics to be determined for the time series are the 22 “catch-22” characteristics, the characteristics function may be referred to as a “catch-22 function” and yield a 22-dimensional vector for each of the 10,000 1,500-length time series.

Turning now to FIG. 3B, auto-encoder 306 is examined in more detail. Auto-encoder 306 consists of an input layer 312, an output layer 314, and several hidden layers. Within the hidden layers, there is a bottleneck layer 316. In one embodiment, input layer 312 and output layer 314 have the same number of nodes as the length of the input time series. For example, where the time series in the initial set are 1,500 observations long, the input layer 312 and output layer 314 both have 1,500 nodes, with one node corresponding to each observation of the time series. The time series may thus be input all at once into the auto encoder 306 at input layer 312, and an estimated time series produced entire at the output layer 314.

The bottleneck layer has the same number N of nodes as there are characteristics of time series extracted by the characteristics function. For example, where the characteristics function produces values for the 22 catch-22 characteristics, precisely 22 nodes are present in bottleneck layer 316. Note, other hidden layers between input layer 312 and bottleneck layer 316 and between bottleneck layer 316 and output layer 314 may be present in auto-encoder 306, but, for simplicity, are not shown in FIG. 3B.

Referring now to FIG. 3C, workflow 300 is expanded to show aspects of training of auto-encoder 306. In one embodiment, a combined loss function 322 is used to train auto encoder 306. Auto encoder 306 is trained so as to minimize combined loss function 322. Combined loss function 322 is configured so as to cause training of auto-encoder 306 to minimize the discrepancies in both a first error function (Error-1 324) and in a second error function (Error-2 326). In one embodiment, Error-1 324 is discrepancies between bottleneck layer 316 activations and corresponding values in catch-22 vectors 308 calculated using the catch-22 function (deterministic). Or, more generally, Error-1 324 is differences between node activations in bottleneck layer 316 for a time series entered at input layer 312 and values of the N characteristics produced by the characteristics function for the time series entered at input layer 312. In one embodiment, Error-2 326 is discrepancies between input layer 312 and output layer 314. In other words, Error-2 326 is differences between the observed values of the time series that is entered into auto-encoder 306 at input layer 312, and the estimated values of the time series that is output by auto-encoder 306 at output layer 314. In one embodiment, combined loss 322 integrates Error-1 324 and Error-2 326 as a weighted sum, with equal weights applied to each of Error-1 324 and Error-2 326. By integrating these two errors in combined loss 322, the training of auto-encoder 306 concurrently minimizes both Error-1 324 and Error-2 326.

At FIG. 3D, auto-encoder 306 is re-configured to operate as a characteristics-based time series generator. After training of auto-encoder 306 is completed, a “first half” of the layers in auto-encoder 306 may be removed. Bottleneck layer 316 is then configured to function as a new input layer in place of input layer 312 in a “second half” 332 of the trained auto-encoder 306. In one embodiment, the “first half” of layers of auto encoder 306 are the layers preceding bottleneck layer 316, including input layer 312. And, in one embodiment, the “second half” 332 are the layers from bottleneck layer 316 to output layer 314, including bottleneck layer 316. Output layer 314, as well as the configuration of the auto-encoder 306 between bottleneck layer 316 and output layer 314 remain unaltered in the second half 332 configuration.

Referring now to FIG. 3E, the algorithm selection system analyzes a vector space of the N characteristics to determine ranges of characteristics that are less represented in the initial collection of time series. These sparse ranges are also referred to as “gaps” in the vector space of the N characteristics (such as the vector space of the catch-22 characteristics). In one embodiment, the algorithm selection system identifies gaps in the vector space of the characteristics with a T-SNE and Data analysis 342. For example, in T-SNE and Data analysis 342, the algorithm selection system identifies the gaps by visualizing the 10,000 catch-22 vectors 308 on a 2D canvas using t-SNE, and then highlights regions in the 22-dimensional vector space where input time series are scarce. In one embodiment, the T-SNE and Data analysis 342 is performed at the same time as (or otherwise in parallel with) the re-configuration of the auto-encoder 306 into the “second half” 332 characteristics-based time series generator. Subsequently, the algorithm selection system generates further characteristics vectors that fill the gaps (which may be used to generate a gap-filling set of time series, as discussed below). For example, the system produces an additional 10,000 characteristics (catch-22) vectors 344. Generation of these additional characteristics vectors ensures a more even distribution by minimizing large gaps between neighboring points in the characteristics vector space.

In one embodiment, the additional characteristics vectors may be used to produce gap-filling time series using the second half of the previously trained auto encoder. Gap-filling time series are time series that have characteristics that fill or close up gaps in the characteristics vector space. In one embodiment, a gap-filling set of time series includes a plurality of gap-filling time series that fill a plurality of gaps in the characteristics vector space. The newly generated 10,000 catch-22 vectors 344 serve as input for the second half 322 of the previously trained auto-encoder 306. The output from inputting the 10,000 catch-22 vectors 344 to the second half 322 of the previously trained auto-encoder 306 is 10,000 new time series 346. As discussed above, inputting a characteristic vector to the bottleneck layer 316 of the trained auto-encoder 306 causes the second half 322 of the trained auto-encoder 306 to produce at the output layer 314 a time series that exhibits the characteristics included in the characteristic vector. Inputting the characteristic vectors that fill the gaps in the characteristic space causes the second half 322 of the trained auto-encoder 306 to produce new time series 346 which exhibit different characteristics than those that were already in the initial set of time series 304, but which remain within the distribution of the initial set of time series 304. In short, inputting the 10,000 catch-22 vectors 344 that fill the gaps in the characteristics vector space into the second half 322 of the trained auto-encoder 306 produces a gap-filling set of time series, 10,000 new time series 346.

Referring now to FIG. 3F, the algorithm selection system provides a dataset containing 10,000 new time series 346 as input to each of a group of candidate forecasting algorithms 348. In one embodiment, the dataset provided to each of the candidate forecasting algorithms 348 is a combined testing dataset that includes both the initial set of time series 304 and the new time series 346. IN one embodiment, the candidate forecasting algorithms 348 include an autoregressive integrated moving average (ARIMA) model 350, an error-trend-seasonality (ETS) model 352, a deep learning model 354, an error feedback estimation (EFE) model 356, and a prophet model 358.

As shown in FIG. 3G, the algorithm selection system determines forecasting errors 359 for the candidate forecasting algorithms 348. A forecasting error is determined for each algorithm and time series. In one embodiment, an ARIMA error 360, an ETS error 362, a deep learning error 364, an EFE error 366, and a prophet error 368 are determined for each individual time series in the testing set. ARIMA error 360 is error between a time series that is input to ARIMA model 350 and the estimated time series that is output from ARIMA model 350. ETS error 362 is error between a time series that is input to ETS model 352 and the estimated time series that is output from ETS model 352. Deep learning error 364 is error between a time series that is input to deep learning model 354 and the estimated time series that is output from deep learning model 354. EFE error 366 is error between a time series that is input to EFE model 356 and the estimated time series that is output from EFE model 356. Prophet error 368 is error between a time series that is input to prophet model 358 and the estimated time series that is output from prophet model 358.

In one embodiment, the forecasting error is calculated as the mean absolute scaled error (MASE). In other embodiments, forecasting error may be calculated as mean squared error (MSE) or mean absolute error (MAE). The forecasting error provides a single-value quantification of how well a candidate forecasting algorithm predicts values of a given time series that has particular characteristics. Thus, the characteristic values that describe a time series may be associated with the predictive performance of a forecasting algorithm on the time series. Once the forecasting error has been generated for each time series, the algorithm selection system ranks the candidate forecasting algorithms 369 based on their performance for each time series in the testing set of time series. In one embodiment, the ranking may be in ascending order of forecasting error. That is, the candidate algorithm that has a least forecasting error for a time series is ranked first in performance for the time series, the candidate algorithm that has a second lowest forecasting error being ranked second in performance, and so on, ranking the candidate algorithm that has a highest forecasting error for the time series being ranked lowest in performance for the time series. These rankings of the candidate forecasting algorithms for a time series may be stored in association with the characteristic vectors for the time series.

Referring now to FIG. 3H, the algorithm selection system proceeds to train a ranking function 370 that assigns a rank to each algorithm based on a provided S-dimensional (e.g., 22-dimensional) characteristics vector that represents the input series. This ranking function 370 is learned by examining the 10,000 pairs of characteristics vectors (such as catch-22 vectors) and the corresponding algorithm ranks for each vector. In one embodiment, the ranking function is a machine learning (ML) classification algorithm configured to assign ranks to the candidate forecasting algorithms as classifications based on input of the S characteristic values. In one embodiment, the ranking function is a multi-class ML classification algorithm, such as k-Nearest Neighbor, Decision Tree, Naive Bayes, Random Forest, or Gradient Boosting algorithm.

Alternatively, in one embodiment the ranking function 370 is a scoring function that is trained to estimate a forecasting error for each candidate forecasting algorithm based on the provided characteristics vector. For example, the ranking/scoring function 370 may be a multi-output ML regression model. ranking/scoring function 370 estimates forecasting errors for applying the various candidate forecasting algorithms to a time series based on the characteristics of the time series.

As shown in FIG. 3I, with the established ranking/scoring function serving as a versatile forecasting algorithm selector, the algorithm selection system can determine how well each of the candidate forecasting algorithms 348 will perform on a given time series 372 based on the characteristics vector 374 (e.g., catch-22 vector) for the time series 372. Time series 372 may be of any length, and may be obtained from diverse domains. Time series 372 is a time series in addition to the initial/training and supplemented/testing sets of time series. In one embodiment, time series 372 is a time series for which a most suitable forecasting algorithm is to be automatically selected to use for forecasting estimates of time series 372. By obtaining the characteristics vector 374 that corresponds to time series 372 and passing that characteristics vector 374 to the trained ranking/scoring function 370, the algorithm selection system can efficiently determine the ranks of algorithms 376 for the candidate forecasting algorithms 348. Ranks of algorithms 376 indicates how accurate the predictions of time series 372 by each of the candidate forecasting algorithms 348 will be.

The algorithm selection system can then choose the top few algorithms 378 (such as the top 3 algorithms) by rank from the list of ranked algorithms. These top few algorithms 378 may then be further evaluated for optimal forecasting performance. The algorithm selection system inputs the time series into each of the top 3 algorithms and calculates their respective rolling-origin cross-validation (ROCV) errors, algorithm 1 ROCV error 380, algorithm 2 ROCV error 382, and algorithm 3 ROCV error 384. In one embodiment, rolling-origin cross-validation is carried out by incrementally training a candidate algorithm on progressively further observations of the time series 372 and comparing a value of the time series in an observation that follows the values used for training with the actual value of the time series at that observation. In other words, the algorithm is trained on the time series 372 up to a cutoff observation, the difference between an actual observation that is a pre-determined number of observations beyond the cutoff observation and an estimate of the actual observation produced by the trained algorithm is recorded, and the cutoff observation is incrementally advanced. This process is repeated in a loop of incremental advances of the cutoff observation, and the ROCV error is calculated from the collection of differences that were recorded. In one embodiment, the ROCV error is calculated using MASE over all of the observations.

The algorithm selection system then utilize the ROCV errors 380, 382, 384 of the top few algorithms 378 for algorithm selection 386. The ROCV error analysis serves as a hedge against overfitting using the testing dataset. At algorithm selection 386, the algorithm selection system ultimately chooses the best-performing algorithm in terms of ROCV error to generate the final forecast. For example, algorithm selection 386 selects as a top algorithm the one of the top few forecasting algorithms 378 that has the lowest of the ROCV errors 380, 382, 384. The top algorithm that is selected by algorithm selection 386 is thus among the top few algorithms 378 by rank of predictive accuracy, and has been confirmed to be least overfit (or not overfit at all) to the testing dataset by the low ROCV error.

The algorithm selection system then deploys the top algorithm for forecasting 388 values of the input time series 372. In one embodiment, the forecasts from the top algorithm will be of high quality, and are produced at a much lower compute (processor and/or memory) cost compared to the standard brute force method. In one embodiment, the algorithm selection systems and methods described herein outperforms methods such as Feature-based FORecast Model Selection (FFORMS) because the algorithm selection systems and methods cover a broader range of domains that FFORMS does not address.

### —Specific Characteristics Used for Time Series Generation—

In one embodiment, a specific set of characteristics of time series is used for time series generation by the characteristics-based time series generator and analysis to determine appropriate forecasting algorithms for a time series. In particular, they are a set of 22 canonical characteristics of time series identified by Carl H. Lubba et al., catch22:Canonical Time-series CHaracteristics, 33 Data Mining and Knowledge Discovery 1821, 1833 (Aug. 9, 2019), available at https://link.springer.com/article/10.1007/si 68-019-00647-x. These 22 characteristics compactly describe how data in a time series evolve or change over time (also referred to as the “dynamics” of a time series). For example, the characteristics may describe underlying processes, trends, and structures that give rise to the observed data points of the time series.

The 22 characteristics are listed in Table 1 below, classified by type of information conveyed.

TABLE 2
Example Characteristics Used by Algorithm Selection System

Distribution
Mode of z-scored distribution (5-bin histogram)
Mode of z-scored distribution (10-bin histogram)
Simple Temporal Statistics
Longest period of consecutive values above the mean
Time intervals between successive extreme events above the mean
Time intervals between successive extreme events below the mean
Linear Autocorrelation
First 1/e crossing of autocorrelation function
First minimum of autocorrelation function
Total power in lowest fifth of frequencies in the Fourier power spectrum
Centroid of the Fourier power spectrum
Mean error from a rolling 3-sample mean forecasting
Nonlinear Autocorrelation
Time-reversibility statistic, {(Xₜ₊₁ − Xₜ)³}t
Automutual information, m = 2, T = 5
First minimum of the automutual information function
Successive Differences
Proportion of successive differences exceeding 0.040
Longest period of successive incremental decreases
Shannon entropy of two successive letters in equiprobable 3-letter
symbolization
Change in correlation length after iterative differencing
Exponential fit to successive distances in 2-d embedding space

In one embodiment, characteristics other than the 22 characteristics listed in Table 1 may also be used for characteristics-based time series generation using a modified auto-encoder.

### Selected Advantages

In one embodiment, the algorithm selection system improves the technology of time series forecasting by providing enhanced forecasting accuracy. By employing the versatile and adaptive algorithm selection approach of the algorithm selection system, more accurate time series forecasting solutions may be constructed. The enhanced forecasting accuracy enables improved decision-making by downstream systems, leading to improved outcomes.

In one embodiment, the algorithm selection system improves the technology of time series forecasting by extending automated forecasting algorithm selection to cross-industry applications where automated algorithm selection was not previously possible. The domain-agnostic nature of the algorithm selection system makes it suitable for a variety of industries that produce time series characteristics other than what is available in public datasets. In one embodiment, thus, the algorithm selection system improves the technology of time series forecasting by providing more accurate forecasting solutions that are tailored to the domain of the time series data provided by a client system for monitoring.

In one embodiment, the algorithm selection system improves the technology of time series forecasting by increasing the efficiency of compute resource usage. For example, the algorithm selection system reduces time and computing resources used for selecting a forecasting model selection and for tuning the forecasting model. Because the forecasting model is trained using a testing set that has been supplemented to fill gaps in the characteristics space, it will need little to no tuning to fit the time series data provided by a client system for monitoring.

In one embodiment, the algorithm selection system improves the technology of time series forecasting by increasing the scalability of forecasting model selection. In particular, the ability of the algorithm selection system to handle a wide range of time series behaviors makes it highly scalable, allowing ready adaptation of a selection model to new markets, industries, or customer needs.

### —Detection of Anomalous Deviation and Electronic Alerts—

In one embodiment, an electronic alert is generated by composing and transmitting a computer-readable message. The computer readable message may include content describing the deviation from predicted values that triggered the alert, such as a time or observation where the deviation was detected, an indication of the time series value that caused the anomaly and a signal source (associated with the additional time series that is being monitored) for which alert is applicable.

In one embodiment, an electronic alert may be generated and sent in response to a detection of a deviation from predicted time series values. For example, the deviation from predicted values may be detected (and found to be sufficient to justify an alert) where residuals between actual and predicted values satisfy a sequential probability ratio test (SPRT) analysis. For example, the SPRT calculates a cumulative sum of the log-likelihood ratio for each successive residual between an actual value for a signal and an estimated value for the signal, and compares the cumulative sum against a threshold value indicating anomalous deviation. Where the threshold is crossed, an anomalous deviation is detected, and an electronic alert indicating the deviation may be generated in response. The electronic alert may be composed and then transmitted for subsequent presentation on a display or other action.

In one embodiment, the electronic alert is a message that is configured to be transmitted over a network, such as a wired network, a cellular telephone network, wi-fi network, or other communications infrastructure. The electronic alert may be configured to be read by a computing device. The electronic alert may be configured as a request (such as a REST request) used to trigger initiation of an automated function in response to detection of an anomalous deviation. In one embodiment, the electronic alert may be presented in a user interface such as a graphical user interface (GUI) by extracting the content of the electronic alert by a REST API that has received the electronic alert. The GUI may present a message, notice, or other indication that the anomalous deviation has occurred.

### Cloud or Enterprise Embodiments

In one embodiment, the present system (such as algorithm selection system 100) is a computing/data processing system including a computing application or collection of distributed computing applications for access and use by other client computing devices that communicate with the present system over a network. In one embodiment, algorithm selection system 100 is a component of a time series data service that is configured to gather, serve, and execute operations on time series data. The applications and computing system may be configured to operate with or be implemented as a cloud-based network computing system, an infrastructure-as-a-service (IAAS), platform-as-a-service (PAAS), or software-as-a-service (SAAS) architecture, or other type of networked computing solution. In one embodiment the present system provides at least one or more of the functions disclosed herein and a graphical user interface to access and operate the functions. In one embodiment, algorithm selection system 100 is a centralized server-side application that provides at least the functions disclosed herein and that is accessed by many users by way of computing devices/terminals communicating with the computers of algorithm selection system 100 (functioning as one or more servers) over a computer network. In one embodiment algorithm selection system 100 may be implemented by a server or other computing device configured with hardware and software to implement the functions and features described herein.

In one embodiment, the components of algorithm selection system 100 may be implemented as sets of one or more software modules executed by one or more computing devices specially configured for such execution. In one embodiment, the components of algorithm selection system 100 are implemented on one or more hardware computing devices or hosts interconnected by a data network. For example, the components of algorithm selection system 100 may be executed by network-connected computing devices of one or more computing hardware shapes, such as central processing unit (CPU) or general-purpose shapes, dense input/output (I/O) shapes, graphics processing unit (GPU) shapes, and high-performance computing (HPC) shapes.

In one embodiment, the components of algorithm selection system 100 intercommunicate by electronic messages or signals. These electronic messages or signals may be configured as calls to functions or procedures that access the features or data of the component, such as for example application programming interface (API) calls. In one embodiment, these electronic messages or signals are sent between hosts in a format compatible with transmission control protocol/internet protocol (TCP/IP) or other computer networking protocol. Components of algorithm selection system 100 may (i) generate or compose an electronic message or signal to issue a command or request to another component, (ii) transmit the message or signal to other components of algorithm selection system 100, (iii) parse the content of an electronic message or signal received to identify commands or requests that the component can perform, and (iv) in response to identifying the command or request, automatically perform or execute the command or request. The electronic messages or signals may include queries against databases. The queries may be composed and executed in query languages compatible with the database and executed in a runtime environment compatible with the query language.

In one embodiment, remote computing systems may access information or applications provided by algorithm selection system 100, for example through a web interface server. In one embodiment, the remote computing system may send requests to and receive responses from algorithm selection system 100. In one example, access to the information or applications may be effected through use of a web browser on a personal computer or mobile device. In one example, communications exchanged with algorithm selection system 100 may take the form of remote representational state transfer (REST) requests using JavaScript object notation (JSON) as the data interchange format for example, or simple object access protocol (SOAP) requests to and from XML servers. The REST or SOAP requests may include API calls to components of algorithm selection system 100.

### Software Module Embodiments

In general, software instructions are designed to be executed by one or more suitably programmed processors accessing memory. Software instructions may include, for example, computer-executable code and source code that may be compiled into computer-executable code. These software instructions may also include instructions written in an interpreted programming language, such as a scripting language.

In a complex system, such instructions may be arranged into program modules with each such module performing a specific task, process, function, or operation. The entire set of modules may be controlled or coordinated in their operation by an operating system (OS) or other form of organizational platform.

In one embodiment, one or more of the components described herein are configured as modules stored in a non-transitory computer readable medium. The modules are configured with stored software instructions that when executed by at least a processor accessing memory or storage cause the computing device to perform the corresponding function(s) as described herein.

### Computing Device Embodiment

FIG. 4 illustrates an example computing system 400 that is configured and/or programmed as a special purpose computing device(s) with one or more of the example systems and methods described herein, and/or equivalents. The example computing device may be a computer 405 that includes at least one hardware processor 410, a memory 415, and input/output ports 420 operably connected by a bus 425. In one example, the computer 405 may include characteristics-based algorithm selection logic 430 that is configured to facilitate characteristics-based selection of time series forecast algorithms, similar to the logic, systems, and other embodiments shown and described herein with reference to FIGS. 1, 2, and 3A-31.

In different examples, the logic 430 may be implemented in hardware, one or more non-transitory computer-readable media 437 with stored instructions, firmware, and/or combinations thereof. While the logic 430 is illustrated as a hardware component attached to the bus 425, it is to be appreciated that in other embodiments, the logic 430 could be implemented in the processor 410, stored in memory 415, or stored in disk 435.

In one embodiment, logic 430 or the computer is a means (e.g., structure: hardware, non-transitory computer-readable medium, firmware) for performing the actions described. In some embodiments, the computing device may be a server operating in a cloud computing system, a server configured in a Software as a Service (SaaS) architecture, a smart phone, laptop, tablet computing device, and so on.

The means may be implemented, for example, as an application-specific integrated circuit (ASIC) programmed to facilitate characteristics-based selection of time series forecast algorithms. The means may also be implemented as stored computer executable instructions that are presented to computer 405 as data 440 that are temporarily stored in memory 415 and then executed by processor 410.

Logic 430 may also provide means (e.g., hardware, non-transitory computer-readable medium that stores executable instructions, firmware) for performing one or more of the disclosed functions and/or combinations of the functions.

Generally describing an example configuration of the computer 405, the processor 410 may be a variety of various processors including dual microprocessor and other multi-processor architectures. A memory 415 may include volatile memory and/or non-volatile memory. Non-volatile memory may include, for example, read-only memory (ROM), programmable ROM (PROM), and so on. Volatile memory may include, for example, random access memory (RAM), static RAM (SRAM), dynamic RAM (DRAM), and so on.

A storage disk 435 may be operably connected to the computer 405 via, for example, an input/output (I/O) interface (e.g., card, device) 445 and an input/output port 420 that are controlled by at least an input/output (I/O) controller 447. The disk 435 may be, for example, a magnetic disk drive, a solid-state drive, a floppy disk drive, a tape drive, a Zip drive, a flash memory card, a memory stick, and so on. Furthermore, the disk 435 may be a compact disc ROM (CD-ROM) drive, a CD recordable (CD-R) drive, a CD rewritable (CD-RW) drive, a digital video disc ROM (DVD ROM) drive, and so on. The storage/disks thus may include one or more non-transitory computer-readable media. The memory 415 can store a process 450 and/or a data 440, for example. The disk 435 and/or the memory 415 can store an operating system that controls and allocates resources of the computer 405.

The computer 405 may interact with, control, and/or be controlled by input/output (I/O) devices via the input/output (I/O) controller 447, the I/O interfaces 445, and the input/output ports 420. Input/output devices may include, for example, one or more network devices 455, displays 470, printers 472 (such as inkjet, laser, or 3D printers), audio output devices 474 (such as speakers or headphones), text input devices 480 (such as keyboards), cursor control devices 482 for pointing and selection inputs (such as mice, trackballs, touch screens, joysticks, pointing sticks, electronic styluses, electronic pen tablets), audio input devices 484 (such as microphones or external audio players), video input devices 486 (such as video and still cameras, or external video players), image scanners 488, video cards (not shown), disks 435, and so on. The input/output ports 420 may include, for example, serial ports, parallel ports, and USB ports.

The computer 405 can operate in a network environment and thus may be connected to the network devices 455 via the I/O interfaces 445, and/or the I/O ports 420. Through the network devices 455, the computer 405 may interact with a network 460. Through the network 460, the computer 405 may be logically connected to remote computers 465. Networks with which the computer 405 may interact include, but are not limited to, a local area network (LAN), a wide area network (WAN), and other networks.

### Definitions and Other Embodiments

In another embodiment, the described methods and/or their equivalents may be implemented with computer executable instructions. Thus, in one embodiment, a non-transitory computer readable/storage medium is configured with stored computer executable instructions of an algorithm/executable application that when executed by a machine(s) cause the machine(s) (and/or associated components) to perform the method. Example machines include but are not limited to a processor, a computer, a server operating in a cloud computing system, a server configured in a Software as a Service (SaaS) architecture, a smart phone, and so on). In one embodiment, a computing device is implemented with one or more executable algorithms that are configured to perform any of the disclosed methods.

In one or more embodiments, the disclosed methods or their equivalents are performed by either: computer hardware configured to perform the method; or computer instructions embodied in a module stored in a non-transitory computer-readable medium where the instructions are configured as an executable algorithm configured to perform the method when executed by at least a processor of a computing device.

While for purposes of simplicity of explanation, the illustrated methodologies in the figures are shown and described as a series of blocks of an algorithm, it is to be appreciated that the methodologies are not limited by the order of the blocks. Some blocks can occur in different orders and/or concurrently with other blocks from that shown and described. Moreover, less than all the illustrated blocks may be used to implement an example methodology. Blocks may be combined or separated into multiple actions/components. Furthermore, additional and/or alternative methodologies can employ additional actions that are not illustrated in blocks. The methods described herein are limited to statutory subject matter under 35 U.S.C. § 101.

The following includes definitions of selected terms employed herein. The definitions include various examples and/or forms of components that fall within the scope of a term and that may be used for implementation. The examples are not intended to be limiting. Both singular and plural forms of terms may be within the definitions.

References to “one embodiment”, “an embodiment”, “one example”, “an example”, and so on, indicate that the embodiment(s) or example(s) so described may include a particular feature, structure, characteristic, property, element, or limitation, but that not every embodiment or example necessarily includes that particular feature, structure, characteristic, property, element or limitation. Furthermore, repeated use of the phrase “in one embodiment” does not necessarily refer to the same embodiment, though it may.

A “data structure”, as used herein, is an organization of data in a computing system that is stored in a memory, a storage device, or other computerized system. A data structure may be any one of, for example, a data field, a data file, a data array, a data record, a database, a data table, a graph, a tree, a linked list, and so on. A data structure may be formed from and contain many other data structures (e.g., a database includes many data records). Other examples of data structures are possible as well, in accordance with other embodiments.

“Computer-readable medium” or “computer storage medium”, as used herein, refers to a non-transitory medium that stores instructions and/or data configured to perform one or more of the disclosed functions when executed. Data may function as instructions in some embodiments. A computer-readable medium may take forms, including, but not limited to, non-volatile media, and volatile media. Non-volatile media may include, for example, optical disks, magnetic disks, and so on. Volatile media may include, for example, semiconductor memories, dynamic memory, and so on. Common forms of a computer-readable medium may include, but are not limited to, a floppy disk, a flexible disk, a hard disk, a magnetic tape, other magnetic medium, an application specific integrated circuit (ASIC), a programmable logic device, a compact disk (CD), other optical medium, a random access memory (RAM), a read only memory (ROM), a memory chip or card, a memory stick, solid state storage device (SSD), flash drive, and other media from which a computer, a processor or other electronic device can function with. Each type of media, if selected for implementation in one embodiment, may include stored instructions of an algorithm configured to perform one or more of the disclosed and/or claimed functions. Computer-readable media described herein are limited to statutory subject matter under 35 U.S.C. § 101.

“Logic”, as used herein, represents a component that is implemented with computer or electrical hardware, a non-transitory medium with stored instructions of an executable application or program module, and/or combinations of these to perform any of the functions or actions as disclosed herein, and/or to cause a function or action from another logic, method, and/or system to be performed as disclosed herein. Equivalent logic may include firmware, a microprocessor programmed with an algorithm, a discrete logic (e.g., ASIC), at least one circuit, an analog circuit, a digital circuit, a programmed logic device, a memory device containing instructions of an algorithm, and so on, any of which may be configured to perform one or more of the disclosed functions. In one embodiment, logic may include one or more gates, combinations of gates, or other circuit components configured to perform one or more of the disclosed functions. Where multiple logics are described, it may be possible to incorporate the multiple logics into one logic. Similarly, where a single logic is described, it may be possible to distribute that single logic between multiple logics. In one embodiment, one or more of these logics are corresponding structure associated with performing the disclosed and/or claimed functions. Choice of which type of logic to implement may be based on desired system conditions or specifications. For example, if greater speed is a consideration, then hardware would be selected to implement functions. If a lower cost is a consideration, then stored instructions/executable application would be selected to implement the functions. Logic is limited to statutory subject matter under 35 U.S.C. § 101.

An “operable connection”, or a connection by which entities are “operably connected”, is one in which signals, physical communications, and/or logical communications may be sent and/or received. An operable connection may include a physical interface, an electrical interface, and/or a data interface. An operable connection may include differing combinations of interfaces and/or connections sufficient to allow operable control. For example, two entities can be operably connected to communicate signals to each other directly or through one or more intermediate entities (e.g., processor, operating system, logic, non-transitory computer-readable medium). Logical and/or physical communication channels can be used to create an operable connection.

“User”, as used herein, includes but is not limited to one or more persons, computers or other devices, or combinations of these.

While the disclosed embodiments have been illustrated and described in considerable detail, it is not the intention to restrict or in any way limit the scope of the appended claims to such detail. It is, of course, not possible to describe every conceivable combination of components or methodologies for purposes of describing the various aspects of the subject matter. Therefore, the disclosure is not limited to the specific details or the illustrative examples shown and described. Thus, this disclosure is intended to embrace alterations, modifications, and variations that fall within the scope of the appended claims, which satisfy the statutory subject matter requirements of 35 U.S.C. § 101.

To the extent that the term “includes” or “including” is employed in the detailed description or the claims, it is intended to be inclusive in a manner similar to the term “comprising” as that term is interpreted when employed as a transitional word in a claim.

To the extent that the term “or” is used in the detailed description or claims (e.g., A or B) it is intended to mean “A or B or both”. When the applicants intend to indicate “only A or B but not both” then the phrase “only A or B but not both” will be used. Thus, use of the term “or” herein is the inclusive, and not the exclusive use.

What is claimed is:

1. One or more non-transitory computer-readable media that include stored thereon computer-executable instructions that when executed by at least a processor of a computer cause the computer to:
create a time series generator by 1) accessing a first set of time series, 2) identifying N characteristics of each time series of the first set of time series, 3) training an auto-encoder with a bottleneck layer of N nodes based on a loss function that minimizes discrepancies between bottleneck layer activations and the N characteristics, and 4) setting the bottleneck layer as an input to the time series generator;
determine gaps in an N-dimensional characteristic space for the first set of time series;
input one or more characteristics vectors that fill the gaps into the bottleneck layer to produce a gap-filling set of time series;
combine the first set of time series with the gap-filling set of time series to generate a combined set of time series;
input the combined set of time series into a plurality of candidate forecasting algorithms, where each candidate forecasting algorithm generates forecast values from the combined set of time series;
determine forecasting errors for the plurality of candidate forecasting algorithms based at least on the forecast values and the combined set of time series;
train a machine learning model to determine ranks of forecasting algorithms for forecasting a given time series based on the forecasting errors and the N characteristics; and
select one algorithm of the candidate forecasting algorithms to generate predictions for the given time series based on at least the ranks.

2. The non-transitory computer-readable medium of claim 1, wherein the bottleneck layer comprises 22 nodes that correspond to 22 characteristics of the time series.

3. The non-transitory computer-readable medium of claim 1, wherein time series in the first set of time series are synthesized to simulate a range of time series behaviors comprising outliers, multiple seasonalities, change-points, intermittency, and high-level effects.

4. The non-transitory computer-readable medium of claim 1, wherein the loss function is configured to minimize discrepancies between the bottleneck layer activations and the characteristics vectors by evaluating a combined error of a) a difference between output and input, and b) a difference between the bottleneck layer and the characteristic features of the first set of time series.

5. The non-transitory computer-readable medium of claim 1, wherein using the bottleneck layer as an input layer allows generation of the combined set of time series from characteristic vectors that are selected to minimize gaps between two nearest points in the N-dimensional characteristics space.

6. The non-transitory computer-readable medium of claim 1, wherein the candidate forecasting algorithms comprise one or more of an autoregressive integrated moving average (ARIMA) model, an error-trend-seasonality (ETS) model, a deep learning model, an error feedback estimation (EFE) model, and a prophet model.

7. The non-transitory computer-readable medium of claim 1, wherein the N characteristics of each time series of the first set of time series include a plurality of characteristics selected from the following characteristics: mode of z-scored distribution, longest period of consecutive values above the mean, time interval between successive extreme events above the mean; time interval between successive extreme events below the mean, first l/e crossing of an autocorrelation function, the first minimum of the autocorrelation function, total power in a lowest portion of frequencies in a Fourier power spectrum, centroid of the Fourier power spectrum, mean error from a rolling multi-sample mean forecasting, a time reversibility statistic, automutual information, first minimum of an automutual information function, proportion of successive differences exceeding a given coefficient of the standard deviation, longest period of successive incremental decreases, Shannon entropy of two successive letters in equiprobable 3-letter symbolization, changes in correlation length after iterative differencing, and exponential fit to successive distances in 2D embedding space.

8. A computing system, comprising:
at least one processor connected to at least one memory;
a non-transitory computer readable medium including instructions stored thereon that when executed by at least the processor cause the processor to:
analyze each time series in a training set of time series to yield a vector of N characteristics for each of the time series;
train an auto-encoder using a loss function that minimizes error: (1) between bottleneck layer activations in the auto-encoder and the vectors of characteristics for the time series, and (2) between an input layer and an output layer of the auto-encoder;
generate one or more new vectors of N characteristics by minimizing gaps between neighboring points in an N-dimensional characteristics space;
generate a testing set of time series based at least in part on inputting the new vectors of N characteristics to the bottleneck layer of the trained auto-encoder;
input the testing set of time series to each of a set of distinct forecasting algorithms, and calculate forecasting error for each algorithm based on performance for each time series;
train a ranking function to assign a rank to each forecasting algorithm based on a provided vector of N characteristics; and
automatically select one of the forecasting algorithms to monitor an additional time series based on processing N characteristics of the additional time series with the ranking function.

9. The computing system of claim 8, wherein the instructions further cause the processor to:
forecast values of the additional time series with the selected forecasting algorithm; and
generate an alert where the forecast values differ from actual values of the additional time series.

10. The computing system of claim 8, wherein the bottleneck layer comprises N nodes that correspond to N characteristics in the vector of N characteristics.

11. The computing system of claim 8, wherein each training time series and testing time series are of an equal length that is between 1000 and 2000 observations.

12. The computing system of claim 8, wherein the analysis of each time series to yield a vector of N characteristics generates the vector to include a full set of catch-22 characteristics.

13. The computing system of claim 8, wherein the instructions to automatically select one of the forecasting algorithms further cause the processor to:
assign ranks to the forecasting algorithms with the trained ranking function based on a N-dimensional vector for the additional time series;
select three top-ranked algorithms from the forecasting algorithms;
calculate the respective cross-validation errors of the top-ranked algorithms with respect to the additional time series; and
select, as the one of the forecasting algorithms, the top-ranked algorithm with the least respective cross-validation error.

14. The computing system of claim 8, wherein the forecasting algorithms comprise one or more of an autoregressive integrated moving average (ARIMA) model, an error-trend-seasonality (ETS) model, a deep learning model, an error feedback estimation (EFE) model, and a prophet model.

15. A computer-implemented method, comprising:
processing a plurality of time series in a training set of time series to yield a vector of N characteristics for each of the plurality of time series;
training an auto-encoder based on a loss function that minimizes discrepancies (1) between activations of nodes in a bottleneck layer of the auto encoder and the vector of N characteristics for the time series entered at an input layer of the auto-encoder, and (2) between values of the time series entered at the input layer and values at an output layer of the auto-encoder;
generating one or more new vectors of N characteristics by minimizing gaps between neighboring points in an N-dimensional characteristics space;
generating a testing set of time series based at least in part on inputting the new vectors of N characteristics to the bottleneck layer of the trained auto-encoder;
inputting the testing set of time series to each of a set of distinct forecasting algorithms, and calculating forecasting error for each algorithm based on performance for each time series;
training a ranking function to assign a rank to each forecasting algorithm based on a provided vector of N characteristics; and
automatically selecting one of the forecasting algorithms to monitor an additional time series based on processing N characteristics of the additional time series with the ranking function.

16. The method of claim 15, wherein automatically selecting one of the forecasting algorithms to monitor an additional time series further comprises:
assigning ranks to the forecasting algorithms with the trained ranking function based on a N-dimensional vector for the additional time series;
selecting three top-ranked algorithms from the forecasting algorithms;
calculating the respective cross-validation errors of the top-ranked algorithms with respect to the additional time series; and
selecting, as the one of the forecasting algorithms, the top-ranked algorithm with the least respective cross-validation error.

17. The computer-implemented method of claim 15, wherein the minimizing gaps between neighboring points in an N-dimensional characteristics space is performed based on t-distributed stochastic neighbor embedding.

18. The computer-implemented method of claim 15, further comprising:
forecasting values of the additional time series with the selected forecasting algorithm; and
generating an alert where the forecast values differ from actual values of the additional time series.

19. The computer-implemented method of claim 15, wherein the length of each time series in the training set and testing set is equal.

20. The computer-implemented method of claim 15, wherein processing a plurality of time series to yield the vectors of N characteristics further comprises generating the vectors of N characteristics to include a full set of catch-22 characteristics.
